(19) United States
(12) Patent Application Publication
(10) Pub. No.: US 2019/0102958 A1
(43) Pub. Date: Apr. 4, 2019

(54) Vehicle identification registration and communication system

(71) Applicant: Manuel Gustavo Garcia Delorrio, Montevideo (UY)

(72) Inventor: Manuel Gustavo Garcia Delorrio, Montevideo (UY)

(21) Appl. No.: 16/147,681

(22) Filed: Sep. 29, 2018

Related U.S. Application Data
(60) Provisional application No. 62/565,506, filed on Sep. 29, 2017.

(51) Int. Cl. G07C 5/00; H04W 4/40; H04W 8/26; H04W 76/14; H04L 29/12; H04W 60/00

(52) U.S. Cl. CPC G07C 5/008; H04W 4/40; H04W 60/00; H04W 76/14; H04L 61/1547; H04W 8/265

(57) ABSTRACT

A computer-implemented system and method for registering vehicle identifications and registering users linked to them, searching users or vehicles for example with portions of user names or portions of vehicle identifications and, sending messages directed to registered users or directed to registered vehicles. In case the messages are directed to a registered vehicle, the message may be received by the user(s) linked to that vehicle in the system. The system may also provide for a method to link several users to a vehicle and several vehicles to a user and, a method for reassigning vehicle identifications to users, as a means to enable the use of vehicle identifications by users with the greatest interest in those particular vehicle identifications.

### CROSS-REFERENCE TO RELATED APPLICATIONS

This application claims the benefit of U.S. Provisional Application No. 62/565,506, filed on Sep. 29, 2017.

### BACKGROUND OF THE INVENTION

Vehicle users (e.g., drivers, owners, managers, etc.) may sometimes need to communicate with another vehicle user. Also, a non-vehicle user such as a pedestrian, a business or a governmental institution may need to communicate with a vehicle user. In a similar fashion, a system or apparatus performing actions on behalf of a vehicle user or a non-vehicle user, may need to communicate with another vehicle user in order to perform its functions properly or more efficiently. Those communications may relate to diverse situations regarding a vehicle and, in most cases, when the only information available to the sender about the intended receiver is the information displayed in the vehicle, its current location and its physical characteristics, there is no practical or easy way to establish a communication channel between the parties.

The current situation leaves vehicle users and non-vehicle users communicating by means of horns, lights, voice and gestures.

### BRIEF SUMMARY OF THE INVENTION

The following presents a simplified summary in order to provide a basic understanding of some novel embodiments described herein. This summary is not an extensive overview, and it is not intended to identify key or critical elements or to delineate the scope thereof. Some concepts are presented in a simplified form as a prelude to the more detailed description that is presented later.

Various embodiments are generally directed to techniques to send messages between senders and receivers using the license plate number of the receiver's vehicle or other information being displayed in said vehicle as an index entry for a contact address of the receiver. Some embodiments are particularly directed to establish a publicly available service that uses vehicle identification information as a search key to access and use a vehicle user's electronic address. In one embodiment, for example, an apparatus may comprise a messaging server component operative to receive and process requests for: registration of users, registration of vehicles with a vehicle identification, linking vehicles to users, searching for registered vehicles or users and returning matching vehicle record information or matching user record information, searching for registered vehicles and returning matching off line communication vehicle record information and, sending messages to users. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE SEVERAL VIEWS OF THE DRAWINGS

Some embodiments are illustrated by way of example and not limitation in the figures of the accompanying drawings.

FIG. 1 illustrates an embodiment of a vehicle identification registration and communication system being used to send and receive a message.

FIG. 2 illustrates an embodiment of a vehicle identification registration and communication system being used to search for a vehicle, sending a message and receiving a message.

FIG. 3 illustrates an embodiment of a vehicle identification registration and communication system being used for a first user registration, a second user registration and linked vehicle registration, a vehicle searching, a message sending and a message receiving.

FIG. 4 illustrates an embodiment of a messaging service.

FIG. 5 illustrates an embodiment of a logic flow for the user registration component.

FIG. 6 illustrates an embodiment of a logic flow for the vehicle registration component.

FIG. 7 illustrates an embodiment of a logic flow for the vehicle link change component.

FIG. 8 illustrates an embodiment of a logic flow for the search component.

FIG. 9 illustrates an embodiment of a logic flow for the message receiving component.

FIG. 10 illustrates an embodiment of a logic flow for the chat update component.

FIG. 11 illustrates an embodiment of a logic flow for the vehicle registration component.

FIG. 12 illustrates an embodiment of a client device.

FIG. 13 illustrates an embodiment of a logic flow for the user registration client component.

FIG. 14 illustrates an embodiment of a logic flow for the vehicle registration client component.

FIG. 15 illustrates an embodiment of a logic flow for the vehicle link change client component.

FIG. 16 illustrates an embodiment of a logic flow for the search client component.

FIG. 17 illustrates an embodiment of a logic flow for the message sending client component.

FIG. 18 illustrates an embodiment of a logic flow for the chat update client component.

FIG. 19 illustrates an embodiment of a user registration form.

FIG. 20 illustrates an embodiment of a vehicle registration form.

FIG. 21 illustrates an embodiment of a vehicle link change registration form.

FIG. 22 illustrates an embodiment of a search request form.

FIG. 23 illustrates an embodiment of a vehicle chat form.

FIG. 24 illustrates an embodiment of a user chat form.

FIG. 25 illustrates an embodiment of a centralized system for the system of FIG. 1.

FIG. 26 illustrates an embodiment of a distributed system for the system of FIG. 1.

FIG. 27 illustrates an embodiment of a computing architecture.

FIG. 28 illustrates an embodiment of a communications architecture.

FIG. 29 illustrates an embodiment of a radio device architecture.

### DETAILED DESCRIPTION OF THE INVENTION

There are many situations in which someone may need to contact the driver or the owner of a vehicle. For example, to tell a driver that he or she has a tail light off, that his or her vehicle is blocking another vehicle in the parking, that his or her car have had physical damage, that the car alarm went off, etc. In many of those situations, it is unlikely that the person that needs to contact the driver or the owner of a vehicle can recognize said vehicle as owned by (or somehow linked to) someone he or she previously knew and, have updated contact information. In other situations, a person may want to establish a relationship concerning his or her vehicle, with another person or business (e.g., a parking, a service provider, etc.) and may want to be able to do so without providing any personal or professional contact details. In other situations, a driver may need to inform something to or ask something from another driver in the road, furthermore, a vehicle control system or a driverless car system may be able to communicate with surrounding cars' analogous systems in order to perform their tasks on behalf of those vehicle users. A solution that enables this kind of communications among others, is disclosed in the present invention. The solution may link publicly available vehicle identification or characteristic information (PAVICI), e.g., license plate numbers, license plate country, license plate state, vehicle's business identification, aerial roof marking, other publicly available electronically transmitted identification information or any other publicly available information regarding the vehicle without limitation; with some kind of electronic address of the person or business driving, owning, managing or somehow related to said vehicles. It is to be noted that the term vehicle may refer to any kinds of vehicles without limitation (e.g. cars, trucks, vans, boats, planes, etc.).

In general, it is not possible in practical terms, to perform authentication of user registration information in the messaging service in order to determine that a user is associated with a vehicle identification provided to said service by said user. This is a problem since PAVICI (e.g. license plate numbers) and corresponding owner contact information needed to perform said authentication may be managed by other systems, e.g., Departments of Motor Vehicles in the US or analogous offices in other countries. Some of the issues that need to be addressed are: (a) the need for personal data privacy when registering a license plate number in a public searchable record (as proposed as a possibility in this invention), (b) the need for a method for PAVICI (most likely license plate numbers) assignment and reassignment to users within the messaging service, (c) the need for modeling the relation of multiple users to multiple vehicles, i.e. a user might have more than one vehicle and a vehicle could be linked to more than one user, (d) the need to limit or personalize the kind of messages that a user wishes to receive through each of her or his registered vehicles, the profile of users that can send messages and the profile of users that will see the vehicle as a search result and, (e) the need to integrate third party applications that can access the system on behalf of registered users in order to provide enhanced functionality to said registered users.

For the communication between the sender and the receiver to take place, there must be a public repository containing some contact information linked to PAVICI, and there must exist some publicly accessible way of using said repository to send messages to vehicle users. Said repository may be a part of a messaging service and may be used as well by pedestrians, businesses, governmental institutions and so on and, it may be part of a more general system, the vehicle identification registration and communication system. Said system may implement, among other functions: registration of users, registration of vehicles with a vehicle identification, assignment of vehicles to users, searching for registered vehicles or users and returning matching vehicle or user record information, searching for registered vehicles and returning matching vehicle record's off-line communication information and, sending messages to users.

Users may access and use the messaging service through any compatible means, e. g., a compatible smart phone application (such as the example endpoint disclosed below), a web application or a third-party application (through the example API disclosed below), etc. Said users may then be registered in the messaging service providing only a user name selected by them and, optionally they may register one or more vehicles as well.

Users may register anonymously (i.e., the messaging service will hold only the client messaging endpoint address) or may opt to register, for example, an email address and a password or a telephone number, allowing said user to log in to his or her account from other devices. Additionally, users may associate other identity provider accounts (e.g., social networks systems) to their messaging service accounts.

Vehicles may be registered using PAVICI corresponding to the vehicle. Registered users may search for vehicles and send messages, among other functions, even though said registered users may not be linked to any vehicle within the system.

Regarding privacy concerns of the public about the use of PAVICI, e. g. license plate numbers, users may register their vehicles (as explained before) with an anonymous account, meaning for user or vehicle registration the messaging service may not require the user to disclose any personal or professional contact or identification information. However, the messaging service may store an electronic address corresponding to the messaging endpoint executing on client devices of said users for communication with the messaging service, e. g., for messaging purposes.

In some embodiments, a system and method for assignment and reassignment of PAVICI within the messaging service may be established. Since it is not possible (in a practical or easy way) to determine the correspondence (e.g., ownership of the vehicle) between users and PAVICI, a solution needs to be implemented to avoid, to the extent possible, the use of a PAVICI by a user with no real interest in the vehicle (e. g., not owning, using or controlling the vehicle). The solution implemented in some embodiments is based on the interest of the real owner to be the assignee of his or her PAVICI within the messaging service and, consequently obtaining a better profile for his or her vehicle and securing the PAVICI ownership within the messaging service. The solution is elegant and effective, the first user that registers a PAVICI is the assignee within the messaging service, however, if a second user registers a vehicle with the same PAVICI and gives it a better profile than the current assignee, the PAVICI is then reassigned (i.e. the latter vehicle is linked to the second user and unlinked from the first user) and, consequently, in subsequent searches for that PAVICI, only the linked vehicle may be presented as a match to the user, therefore subsequent messages to that vehicle will be now received by said second user and not anymore by the previous assignee (i.e., first user). There may be a profile level from which it may not be possible to reassign a vehicle identification by means of this specific procedure.

In some embodiments, there may be a registration process for user registration and a different, independent one for vehicle registration. There may also be a different, independent process for linking or unlinking users to vehicles. This distinction may enable the messaging service to link several users to a vehicle (e.g., fleet vehicle drivers and manager or family members) and several vehicles to a user (e.g., a fleet manager). This feature also enables registration of non-vehicle related users (e.g., parking managers, service providers, emergency services, etc.).

In some embodiments, there may be a vehicle profile update process. Through said process, the user linked to said vehicle may register or update an emergency contact, a medical contact, any relevant medical or health related information, a mechanical service and an insurance contact. In all cases those contacts will be registered or updated as user identifications or vehicle identifications previously registered in the messaging service. This contact information may be displayed in the vehicle's public profile and may be of help in an emergency situation in order to get proper assistance.

In said vehicle profile, the user linked to said vehicle, may update the vehicle status to ‘Normal’, ‘Mechanical Failure’, ‘Stolen’, ‘For Sale’, ‘For Sale or Trade’, and other states without limitation. Said user may register or update vehicle identification aliases such as an aerial roof marking: ‘RF 35’ or a vehicle's business identification: ‘Joe's Pizza Delivery #3’. Data in the vehicle profile may be used to match with the search query information when vehicles are being searched for.

In some embodiments, there may be a process for personalizing the kind of messages that can be received through a registered vehicle. The user bearing the registration of a vehicle may be able to configure the system in order to establish that said vehicle may or may not receive text messages (or other kinds of messages or communications, such as images, audio files, video files, audio calls, video calls, conferences, etc.) from other vehicles with the same profile level, or that she or he may or may not receive any kinds of messages form vehicles with a lower profile level, not even fixed preformatted text messages. In addition, the user may block other users or vehicles individually for a period or indefinitely, so it may not be possible for those users or vehicles, during the blocking period, to send messages to the first user. However, the system may not allow to limit the reception of emergency alert messages from non-blocked users.

In some embodiments, the users may request to download off line communication information from other vehicles (e.g., vehicles from a certain area) in order to allow direct (i.e. off line, not using the internet nor the messaging service) communication with those vehicles through the means stated in said information (e.g., WiFi, Bluetooth, LiFi, Radio, etc.). In this scenario (i.e., off-line operation of the messaging endpoints), the messaging endpoint may attempt to establish a direct communication channel with the other vehicle, given that said vehicle has a corresponding record in the local storage of off-line communication information. Once the communication channel and the connection are established, the messaging endpoints may initiate a communication session and may interchange messages and/or other forms of communication without limitation.

In some embodiments, the messaging service may have an application programming interface (API) for connecting other third-party systems, such as a camera app with a license plate number recognition function that sends PAVICI to the messaging service on behalf of a user of the messaging service. In this example, said user may be a parking lot, a drive-through restaurant or a gas station manager and may send, using its own system and the API, a welcome message or special offers to its arriving customers. The messaging service may enable those search matchings and/or communications with said vehicle only if said vehicle's profile is configured to do so by its user. In addition, vehicle users may associate a payment method to their user account within the messaging service and authorize payments in said places where the license plate number of their vehicle has been detected. The messaging service may further verify the proximity of the merchant and the vehicle user using GPS localization information provided by the operating system or platform on which the client messaging endpoint is executing. Third party applications may implement every client functionality disclosed in the present invention and others, the embodiments are not limited by these examples.

In some embodiments, the vehicle identification registration and communication system may present to its users with a vehicular feed. Said vehicular feed may be comprised of a set of chats or publications between other users in a certain geographic area or from a certain group of users with common characteristics or having vehicles with some common characteristics or other combinations of restrictions without limitation. The vehicular feed may be presented to the user in a continuous scrolling screen or list of items that the user may be able to read or interact with.

Said users may rate the vehicular feed content (e.g., the publications, the chats, the individual messages, the users, the vehicles). Said ratings may be executed in the form of a punctuation given, a plus or minus, a symbol, a word or other form of rating that may be related to the contribution of the rated content to the community in terms of vehicular education or traffic education or other criteria without limitation.

User may configure their profile in relation to a specific piece of content or in relation to a specific user or vehicle, in order to get a notification in the event said content gets modified (e.g. a chat that gets another message) or in the event the user or vehicle makes a publication of any kind.

Users may configure their profile in order to receive a notification only in specific events or to not receive a notification in specific events.

In a similar fashion as explained in relation to the vehicular feed content, the vehicle identification registration and communication system may present to its users with a functionality that may enable them to rate the driving performance of the registered vehicle's drivers. Said performance rating method may have a similar purpose as the special service that is nowadays displayed in the back of many business fleet vehicles (e.g. ‘How am I driving? Please call xxx-xxx-xxxx.’).

Said driving performance rating may be displayed in the vehicle profile or not, depending on the profile of the vehicle, the configuration established by the user or other restrictions without limitation.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

It is worthy to note that “a” and “b” and “c” and similar designators as used herein are intended to be variables representing any positive integer. Thus, for example, if an implementation sets a value for a=5, then a complete set of components 122 illustrated as components 122-1 through 122-a may include components 122-1, 122-2, 122-3, 122-4 and 122-5. The embodiments are not limited in this context.

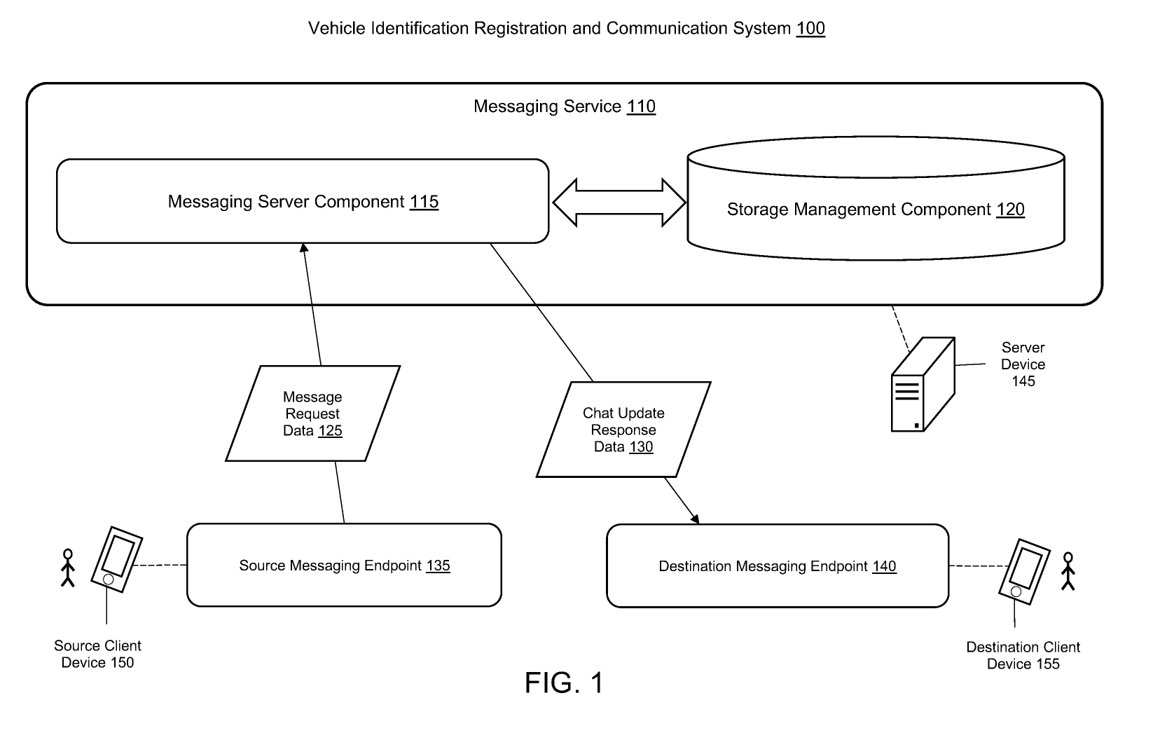

FIG. 1 illustrates a block diagram for a vehicle identification registration and communication system 100. In one embodiment, the vehicle identification registration and communication system 100 may comprise a computer-implemented system having software applications comprising one or more components. Although the vehicle identification registration and communication system 100 shown in FIG. 1 has a limited number of elements in a certain topology, it may be appreciated that the vehicle identification registration and communication system 100 may include more or less elements in alternate topologies as desired for a given implementation.

A messaging service 110 may be generally arranged to receive, store, and deliver messages. The messaging service 110 may store messages while messaging endpoints 135, 140, such as may execute on source client device 150 and destination client device 155, are offline and it may deliver the messages once the messaging endpoints are available.

A source client device 150 may execute source messaging endpoint 135 and a destination client device 155 may execute destination messaging endpoint 140 for the messaging service 110, wherein each of the client devices 150, 155 may be cellular devices such as smartphones and may be identified to the messaging service 110 based on a systemwide-unique user identification associated with each of the messaging endpoints 135, 140. In some embodiments, each messaging endpoint may be associated with a user account registered with the messaging service 110. In general, each messaging endpoint may be addressed through various techniques for the reception of messages, which may include the reception of media items. While in some embodiments the client devices 150, 155 may comprise cellular devices, in other embodiments one or more of the client devices 150, 155 may include personal computers, tablet devices, any other form of computing device without limitation.

A server device 145 may execute a messaging service 110, wherein the server device 145 may comprise any form of computing device without limitation.

The source messaging endpoint 135 may request to transmit a message to the destination messaging endpoint 140 via the messaging service 110. The request to transmit said message may consist of a message package transmitted via the Internet from the source messaging endpoint 135 to the messaging service 110. The messaging server component 115 may receive message request data 125 from the source messaging endpoint 135, said data may comprise the message content and information identifying the destination, at least a portion of the message request data 125 may be stored in the storage management component 120. The destination messaging endpoint 140 may receive chat update response data 130 with the message content sent from the source messaging endpoint 135.

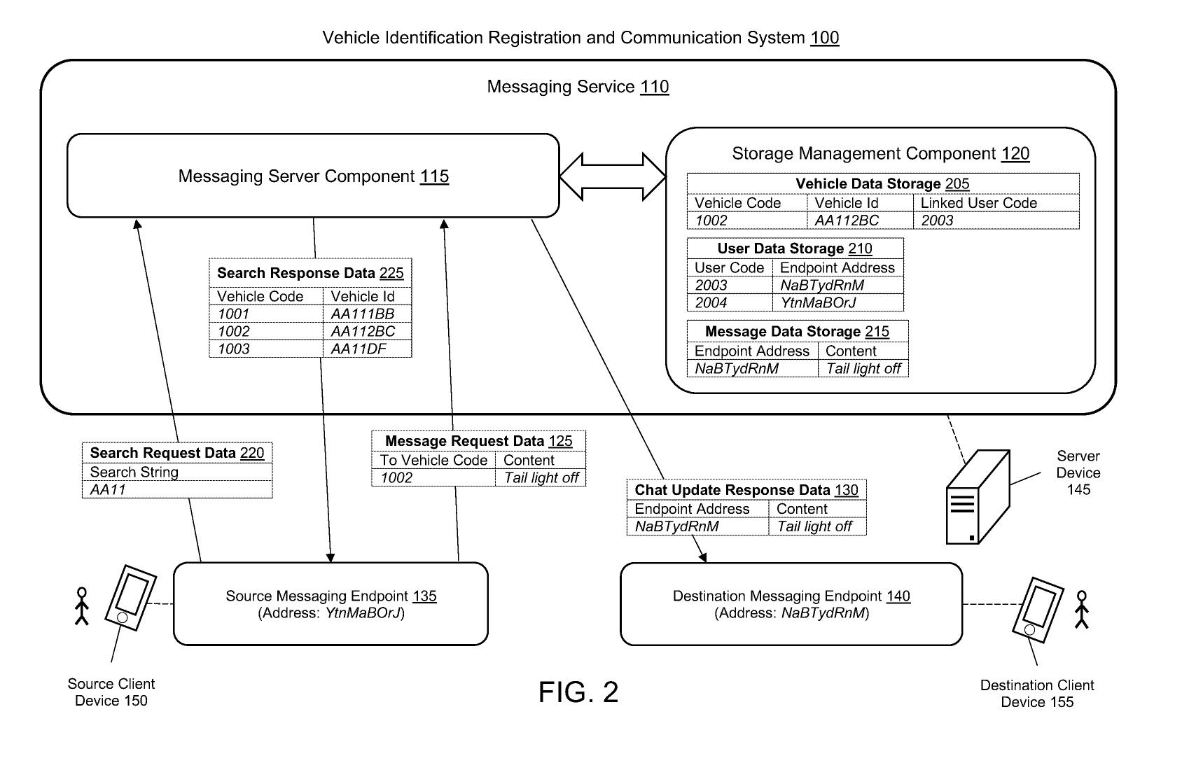

FIG. 2 illustrates an embodiment of a vehicle identification registration and communication system 100 being used to perform a vehicle search by a portion of a vehicle identification, a message sending request and a reception of said message.

The user of the source client device 150—the sender—may need to send a message to the vehicle with license plate number ‘AA112BC’. To do so, the sender may search for the vehicle's plate number in the system. Given that said vehicle is already registered with its license plate number, the sender may search and find it. The source messaging endpoint 135 may transmit search request data 220 to the messaging server component 115 of the messaging service 110, said messaging service 110 may be executing on the server device 145, the search request data 220 comprising a portion of said vehicle's license plate number (i.e. ‘AA11’). A request to perform a search of registered vehicles or registered users may be performed by the messaging server component 115. Said messaging server component 115 may respond to said source messaging endpoint 135 with search response data 225, the search response data 225 comprising information of the plurality of matching records within the system at the time the search is performed.

The sender may select the exact vehicle from the matching information returned and now send the message directed to said vehicle. The source messaging endpoint 135 may transmit message request data 125 to the messaging server component 115, said message request data 125 comprising the message content and information identifying the one or more vehicles (or the one or more users) to whom the message is to be addressed. In some embodiments, said information may comprise a systemwide-unique vehicle identification (or a systemwide-unique user identification). In other embodiments, the message content and the receiver's identification may be transmitted in different messaging steps, adding a common message identification to said steps, so as to disentangle the message content from the receiver's identification and thereby increasing the privacy of the messaging service.

The messaging server component 115 may search for the destination vehicle's linked user code in the vehicle data storage 205 of the storage management component 120, after that, said component may search for the endpoint address of that user code in the user data storage 210 and finally, it may save the message in the message data storage 215.

The messaging server component 115 may transmit notification data to the destination messaging endpoint 140 using an endpoint identification provided by the destination client device's 155 operating system for the purpose of instant notifications, as any skilled artisan would know. In other embodiments, notification data may be transmitted as a response to a mailbox update request made periodically by the destination messaging endpoint 140 to the messaging server component 115. Notification data may comprise a portion of the message content and information of the user's account status. The destination messaging endpoint 140 may not be on line, in such case, the message may be directed by the messaging server component 115 to be stored for later delivery.

The messaging server component 115 may receive a chat update request from the destination messaging endpoint 140. Said chat update request may comprise the user identification, the user's account identification and/or the user's message receiving capable address. In some embodiments, said identifications and address may be all the same information (e.g. the destination messaging endpoint 140 address) for a given user.

The messaging server component 115 may transmit chat update response data 130 to the destination messaging endpoint 140. Said chat update response data 130 may comprise message content from a plurality of unread messages for the receiver.

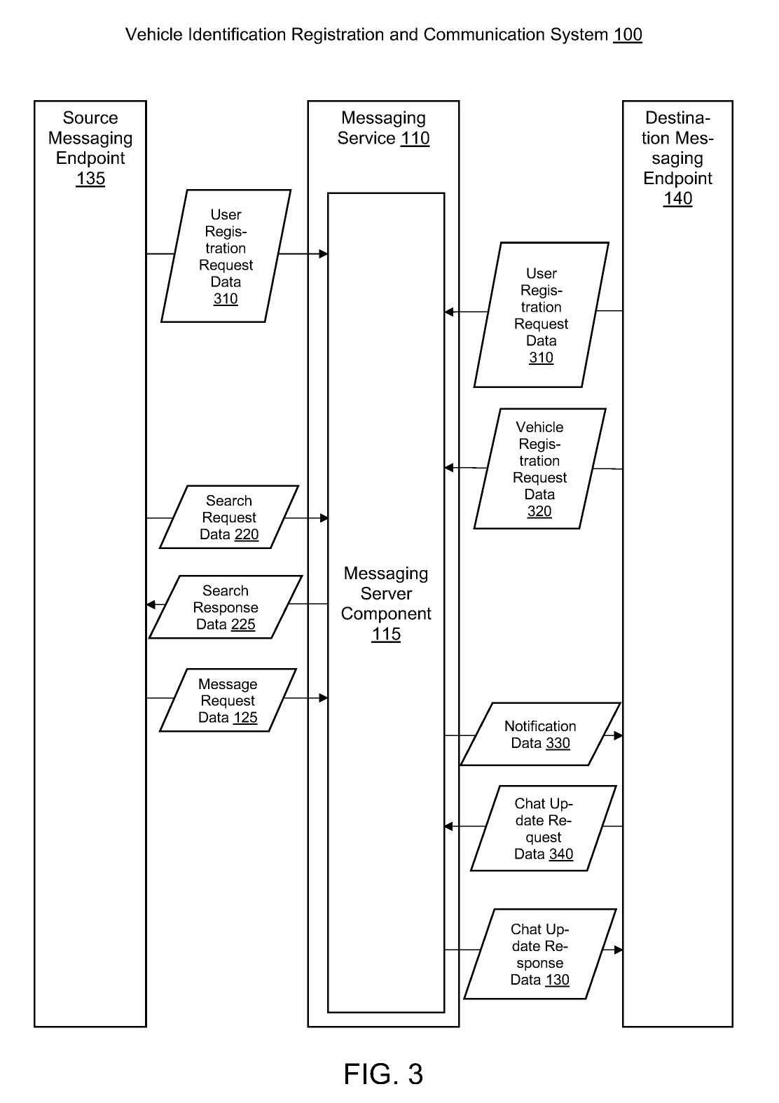

FIG. 3 illustrates a block diagram of a vehicle identification registration and communication system 100 being used to perform a vehicle search, a message sending request and a reception of messages.

A first user—the sender—may self-register in the system using a device executing the source messaging endpoint 135. Said source messaging endpoint 135 may transmit user registration request data 310 to the messaging server component 115 comprising a user selected name.

A second user—the receiver—may self-register in the system using a device executing the destination messaging endpoint 140. Said destination messaging endpoint 140 may transmit User registration request data 310 to the messaging server component 115 comprising none or one user selected name.

In both user registration events, the system may associate a systemwide-unique identification for each registered user. Said identification may be provided by the user or may be generated by the messaging service 110 and, it may comprise a pseudo randomly generated character string verified as unique within the messaging service 110 or, a positive integer autoincremented by a data management system or, a unique identification from another domain e. g., a telephone number, as any skilled artisan would know. License plate numbers may not be considered as a unique identification form another domain, since it is well known that the same plate numbers do exists in different states records and in different countries records.

Said second user may register his or her vehicle using said destination messaging endpoint 140. Said destination messaging endpoint 140 may transmit vehicle registration request data 320 to the messaging server component 115 comprising PAVICI and the receiver's systemwide-unique user identification.

The sender may need to send a message to said vehicle. To do so, the sender may search for the vehicle's plate number in the messaging service 110. Given that said vehicle is already registered with its license plate number, the sender may search and find it. The source messaging endpoint 135 may transmit search request data 220 to the messaging server component 115 of the messaging service 110, the search request data 220 comprising at least a portion of said vehicle's license plate number. A request to perform a search of registered vehicles or registered users may be performed by the messaging server component 115. Said messaging server component 115 may respond to said source messaging endpoint 135 with search response data 225, the search response data 225 comprising information of the plurality of matching records within the system at the time the search is performed.

The sender may select the exact vehicle from the matching information returned and now send the message directed to said vehicle. The source messaging endpoint 135 may transmit message request data 125 to the messaging server component 115, said message request data 125 comprising the message content and information sufficient for the messaging service 110 to identify the vehicle or vehicles (or the user or users) to whom the message is to be addressed. In some embodiments, said information may comprise a unique vehicle identification (or a unique user identification) within the messaging service 110. In other embodiments, the message content and the receiver's identification may be transmitted in different messaging steps, adding a common message identification to said steps, so as to disentangle the message content from the receiver's identification and thereby increasing the privacy of the messaging service 110.

The messaging server component 115 may transmit Notification data 330 to the destination messaging endpoint 140 using an endpoint identification provided by said device's operating system for the purpose of instant notifications, as any skilled artisan would know. In other embodiments, Notification data 330 may be transmitted as a response to a mailbox update request made periodically by the destination messaging endpoint 140 to the messaging server component 115. Notification data 330 may comprise a portion of the message content and information of the user's account status. The destination messaging endpoint 140 may not be on line, in such case, the message may be directed by the messaging server component 115 to be stored for later delivery.

The messaging server component 115 may receive chat update request data 340 from the destination messaging endpoint 140. Said chat update request data 340 may comprise the user identification, the user's account identification or the user's message receiving capable address. In some embodiments, said identifications and address may be all the same information (e.g. the messaging endpoint identification) for a given user.

The messaging server component 115 may transmit chat update response data 130 to the destination messaging endpoint 140. Said chat update response data 130 may comprise message content from a plurality of unread messages for the receiver.

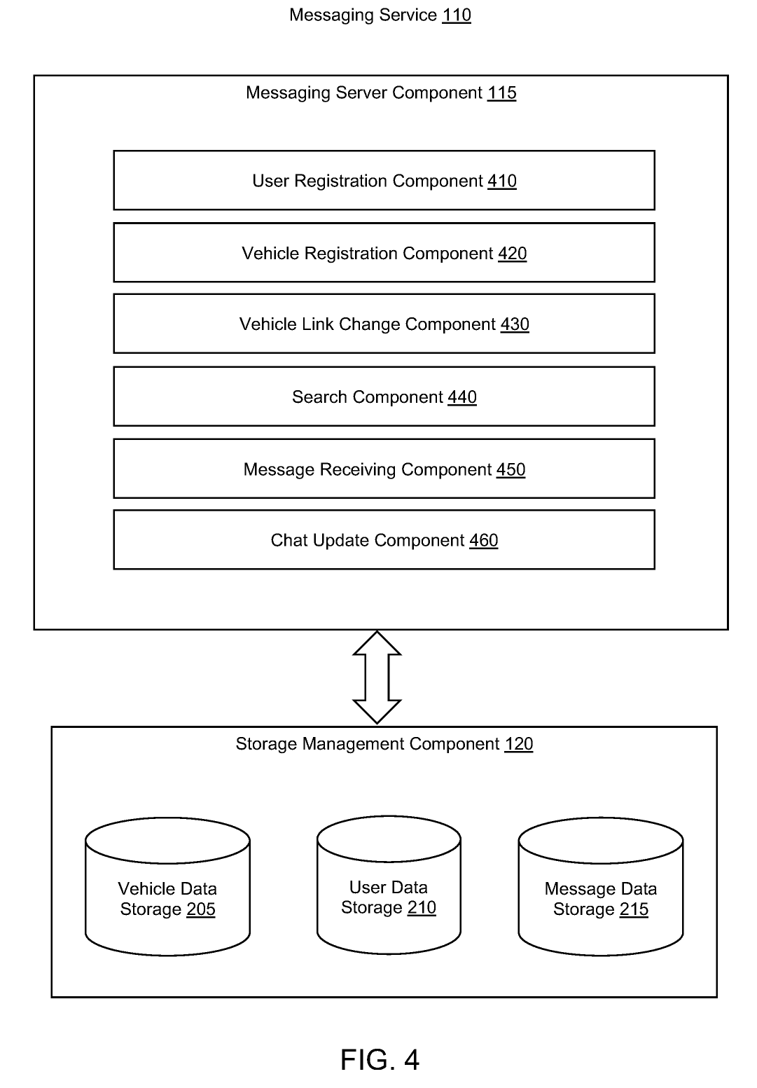

FIG. 4 illustrates an embodiment of a messaging service 110.

The messaging service 110 may comprise a messaging server component 115 and a storage management component 120. Said storage management component 120 may store message content (e.g., text, images, video, audio) in transit between messaging endpoints and multimedia cached for offline endpoints.

A messaging server component 115 may comprise a user registration component 410, a vehicle registration component 420, a vehicle link change component 430, a search component 440, a message receiving component 450 and a chat update component 460.

A messaging server component 115 may perform the core functions of the messaging service 110, i.e., the functions performed by components 410, 420, 430, 440, 450 and 460, and may access and use the storage management component 120 for performing data storage and retrieval management.

A storage management component 120 may comprise a vehicle data storage 205, a user data storage 210 and a message data storage 215.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

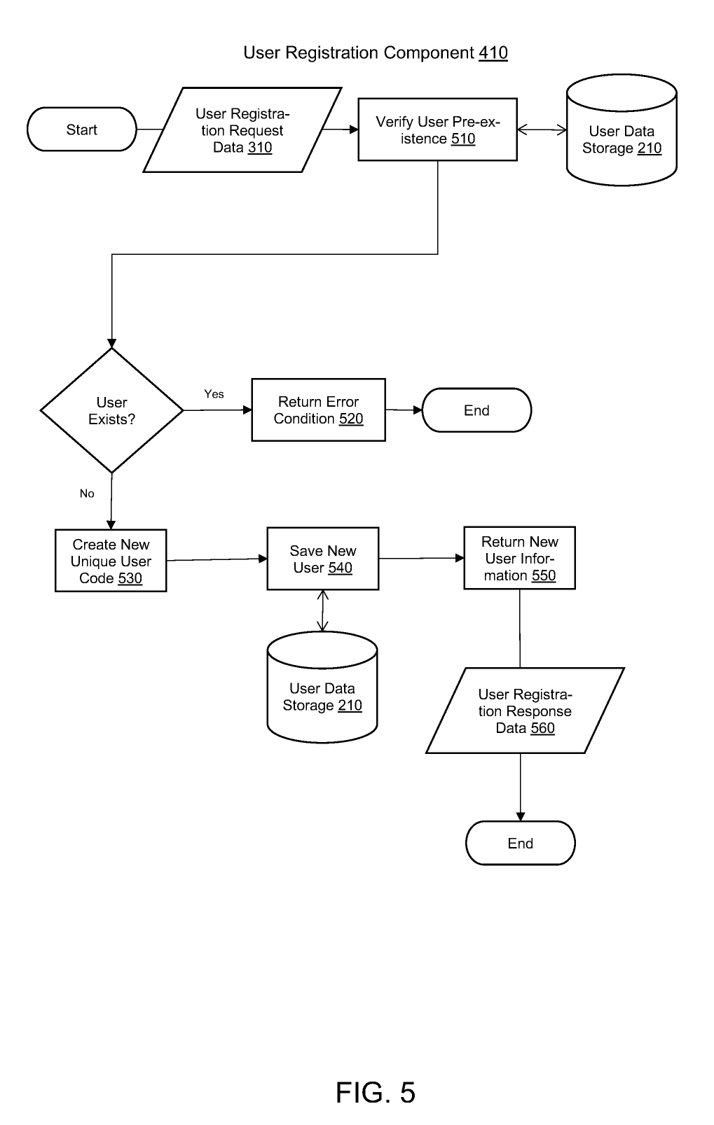

FIGS. 5 to 11 and FIGS. 13 to 18 illustrates different embodiments of logic flows. Those logic flows may be representative of some or all of the operations executed by one or more embodiments described herein. The embodiments are not limited by these examples.

FIG. 5 illustrates an embodiment of a user registration component 410 performing a user registration.

The user registration component 410 may receive user registration request data 310 comprising a user selected name and, at block 510, verify user pre-existence in the user data storage 210. Said verification may be performed by checking if the user selected name received is already recorded in another user record in the user data storage 210.

In case the user selected name previously exists, the user registration component 410 may return an error condition at block 520, making no changes to the user data storage 210.

In case the user selected name does not exists in any other user record in the user data storage 210, the user registration component 410 may create a new unique user code at block 530 and may save the newly created user record at block 540 in the user data storage 210. Said user record may comprise the user registration request data 310 and said new unique user code. Once the user is created and recorded, the user registration component 410 may return user registration response data 560 at block 550 comprising the systemwide-unique user identification of the newly created user record.

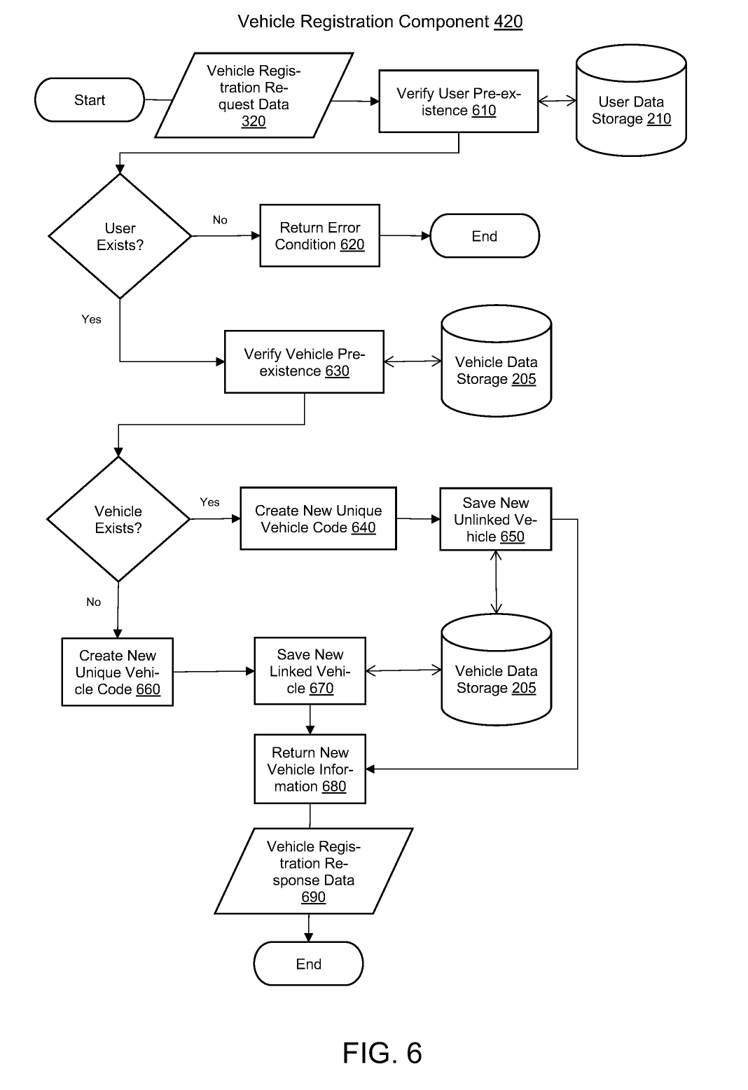

FIG. 6 illustrates an embodiment of a vehicle registration component 420 performing a vehicle registration.

The vehicle registration component 420 may receive vehicle registration request data 320 comprising systemwide-unique user identification and PAVICI and, verify user pre-existence at block 610 in the user data storage 210. Said verification may be performed by checking if the systemwide-unique user identification received is already recorded in some user record in the user data storage 210.

In case the user does not previously exists, the vehicle registration component 420 may return an error condition at block 620, making no changes to the vehicle data storage 205.

In case the user does previously exists, the vehicle registration component 420 may verify vehicle pre-existence in the vehicle data storage 205 at block 630. Said verification may be performed by checking if the PAVICI received is already recorded in another vehicle record in the vehicle data storage 205.

In case the vehicle previously exists, the vehicle registration component 420 may create a new unique vehicle code at block 640 and may save a newly created vehicle record in the vehicle data storage 205 at block 650. Said vehicle record may comprise the vehicle registration request data 320, said new unique vehicle code and, may not comprise a systemwide-unique user identification because the vehicle record may not be linked to any user.

A vehicle linked to a user meaning said user's device may receive the messages directed to said vehicle's systemwide-unique vehicle identification.

Once the unlinked vehicle is created and recorded, the vehicle registration component 420 may return vehicle registration response data 690 at block 680 comprising the systemwide-unique vehicle identification of the newly created vehicle record.

In case the vehicle does not previously exists, the vehicle registration component 420 may create a new unique vehicle code at block 660 and may save a newly created vehicle record in the vehicle data storage 205 at block 670. Said vehicle record may comprise said new unique vehicle code, at least a portion of the vehicle registration request data 320 and, the systemwide-unique user identification included in said vehicle registration request data 320, meaning the vehicle record may be linked to said user record. Once the linked vehicle is created and recorded at blocks 660 and 670, the vehicle registration component 420 may return vehicle registration response data 690 at block 680 comprising the systemwide-unique vehicle identification of the newly created vehicle record.

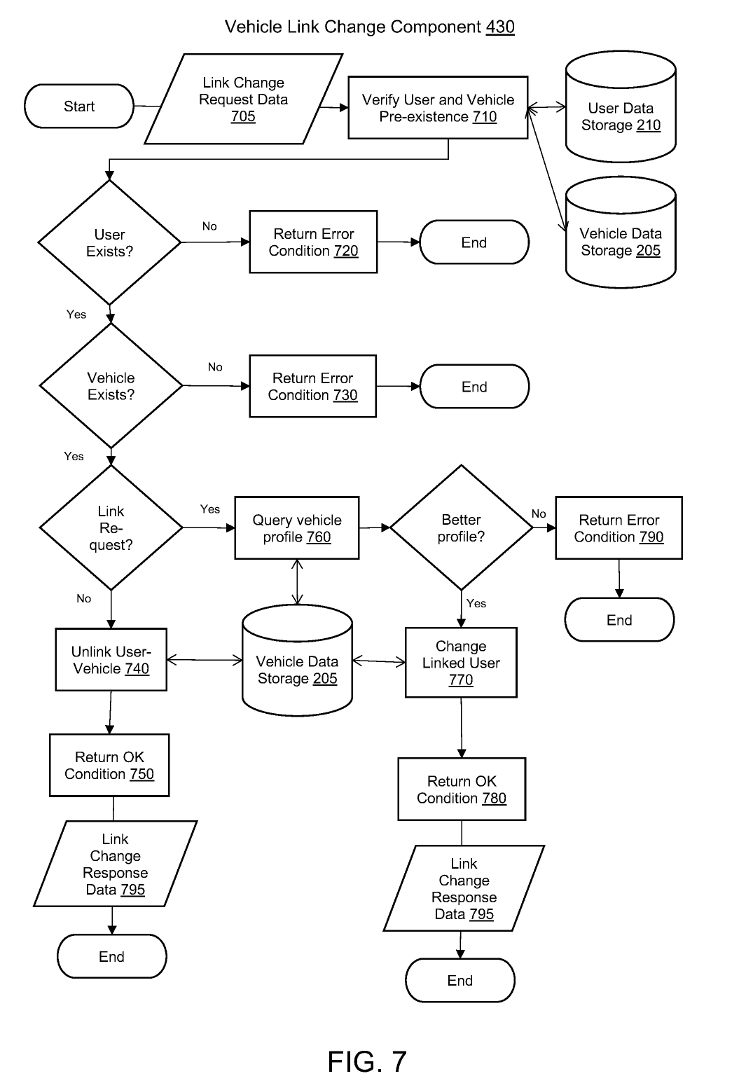

FIG. 7 illustrates an embodiment of a vehicle link change component 430 performing a vehicle link change.

The vehicle link change component 430 may receive vehicle link change request data 705 comprising systemwide-unique user identification, systemwide-unique vehicle identification and request type (link or unlink) and, verify user and vehicle pre-existence in the user data storage 210 and in the vehicle data storage 205 at block 710. Said user verification may be performed by checking if the systemwide-unique user identification received is already recorded in a user record in the user data storage 210. Said vehicle verification may be performed by checking if the systemwide-unique vehicle identification received is already recorded in a vehicle record in the vehicle data storage 205.

In case the user does not previously exists, the vehicle link change component 430 may return an error condition at block 720, making no changes to the vehicle data storage 205.

In case the user does previously exists and the vehicle does not previously exists, the vehicle link change component 430 may return an error condition at block 730, making no changes to the vehicle data storage 205.

In case the user and vehicle previously exists, the vehicle link change component 430 may determine if a link or an unlink is being requested, according to the type of request received in the vehicle link change request data 705.

In case the request is an unlink request and the user and vehicle are previously linked, the vehicle link change component 430 may record the unlink of said user and said vehicle in the vehicle data storage 205 at block 740. The vehicle link change component 430 may then return link change response data 795 at block 750 comprising the systemwide-unique vehicle identification and the systemwide-unique user identification now unlinked and the request type (unlink).

In case the request is a link request, the vehicle link change component 430 may query to the vehicle data storage 205 at block 760 the profile of the vehicle being requested to be linked to the systemwide-unique user identification received in the vehicle link change request data 705 and also the profile of other vehicle or vehicles with the same PAVICI currently linked to other systemwide-unique user identification or identifications.

If there is no currently linked vehicle or, the profile of the vehicle being requested to be linked to the systemwide-unique user identification received in the vehicle link change request data 705 is better than the profile of the currently linked vehicle, then the link change may be recorded in the vehicle data storage 205 at bloc 770, recording that the systemwide-unique vehicle identification may now be linked to the systemwide-unique user identification. The vehicle link change component 430 may then return link change response data 795 at block 780 comprising the systemwide-unique vehicle identification and the systemwide-unique user identification now linked and the request type (link).

If there is a currently linked vehicle and the profile of the vehicle being requested to be linked to the systemwide-unique user identification received in the vehicle link change request data 705 is not better than the profile of the currently linked vehicle, then the vehicle link change component 430 may return an error condition at block 790 without making any changes to the vehicle data storage 205.

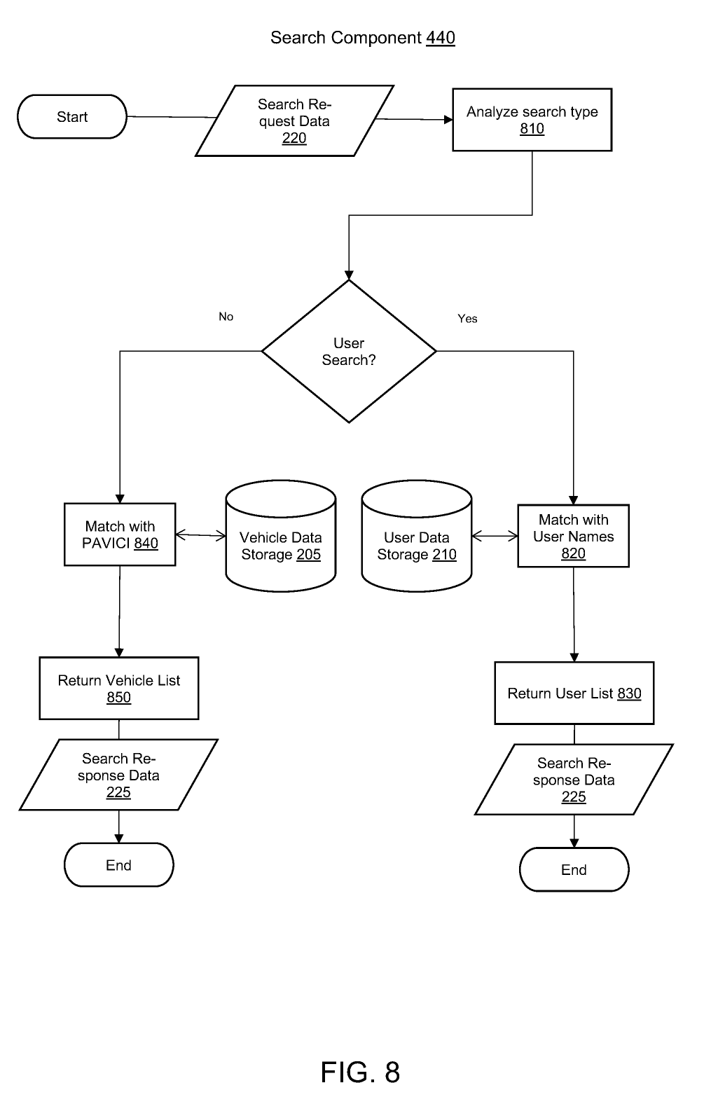

FIG. 8 illustrates an embodiment of a search component 440 performing a vehicle or user search.

The search component 440 may receive search request data 220, said search request data 220 may comprise a search string and an indication whether said search string may correspond to at least a portion of PAVICI or to at least a portion of user selected name and, it may verify which kind of search is being requested (i.e., vehicle or user search) at block 810.

If the requested search is a user search, then the search component 440 may match the search string received in the search request data 220 with the user selected name in the user data storage 210 at block 820 and, return search response data 225 comprising a list of matching users at block 830.

If the requested search is not a user search (i.e., it is a vehicle search), then the search component 440 may match the search string received in the search request data 220 with the PAVICI in the vehicle data storage 205 at block 840 and, return search response data 225 comprising a list of matching vehicles at block 850.

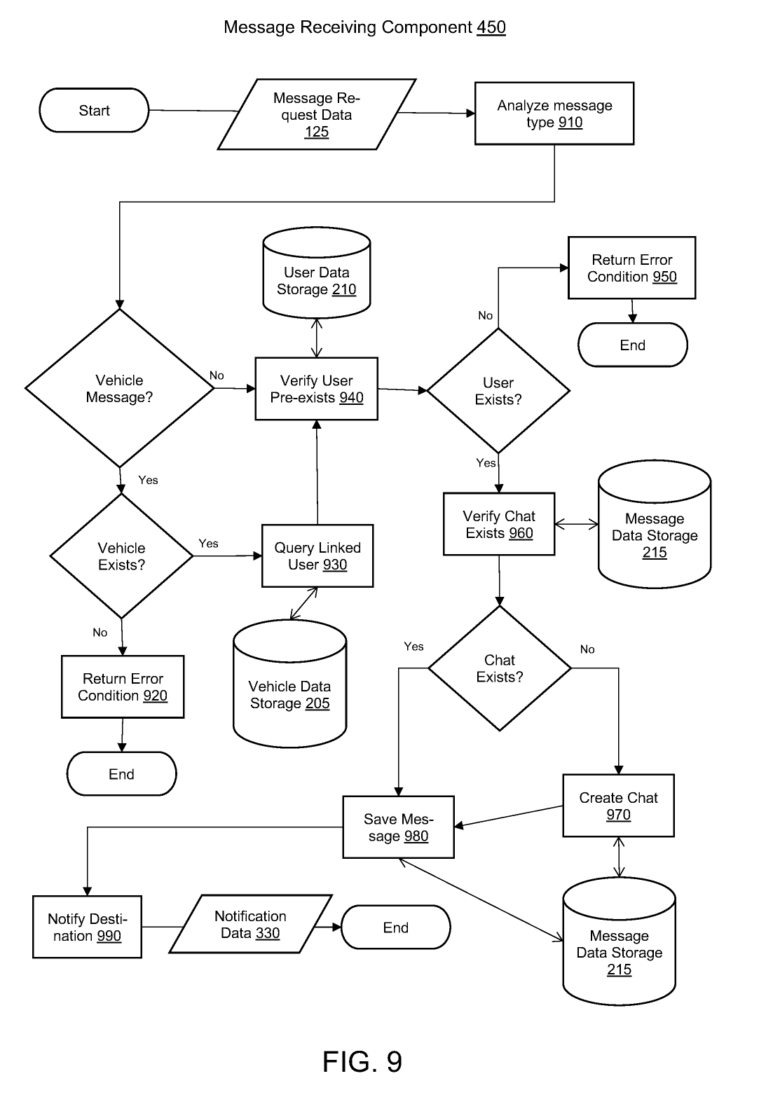

FIG. 9 illustrates an embodiment of a message receiving component 450 performing a reception and storage of a message and, if the intended receiver is on line, notifying said receiver.

The message receiving component 450 may receive and analyze at block 910, the message request data 125 comprising the message content, the kind of message receiver (i.e., user or vehicle) and one or more systemwide-unique user identification or one or more systemwide-unique vehicle identification depending on the kind of message received.

In case the message is addressed to a vehicle, the message receiving component 450 may verify the pre-existence of the vehicle and in case the vehicle does not exists, it may return an error condition at block 920. In case the vehicle exists, the message receiving component 450 may query (to the vehicle data storage 205) the user linked to said vehicle at block 930.

In case the message is addressed to a user or, when in the previous case, the message receiving component 450 has determined at block 930 the linked user of the intended message destination vehicle, the message receiving component 450 may verify the user pre-existence, querying the user data storage 210 at block 940. In case the user does not exists, it may return an error condition at block 950.

In case the user exists, the message receiving component 450 may verify the existence of a chat record (i.e., a previous conversation record between sender and receiver) at block 960 and, in case it does not exists, it may create a new one and store it in the message data storage 215 at block 970. In case the chat does previously exists or, when in the previous case, the message receiving component 450 has created a new chat record, the message receiving component 450 may save the message for future delivery in the message data storage 215 at block 980.

The message receiving component 450 may send notification data 330 at block 990 comprising at least a chat identification so the destination messaging endpoint 140 may try to fetch unread messages from the messaging service 110.

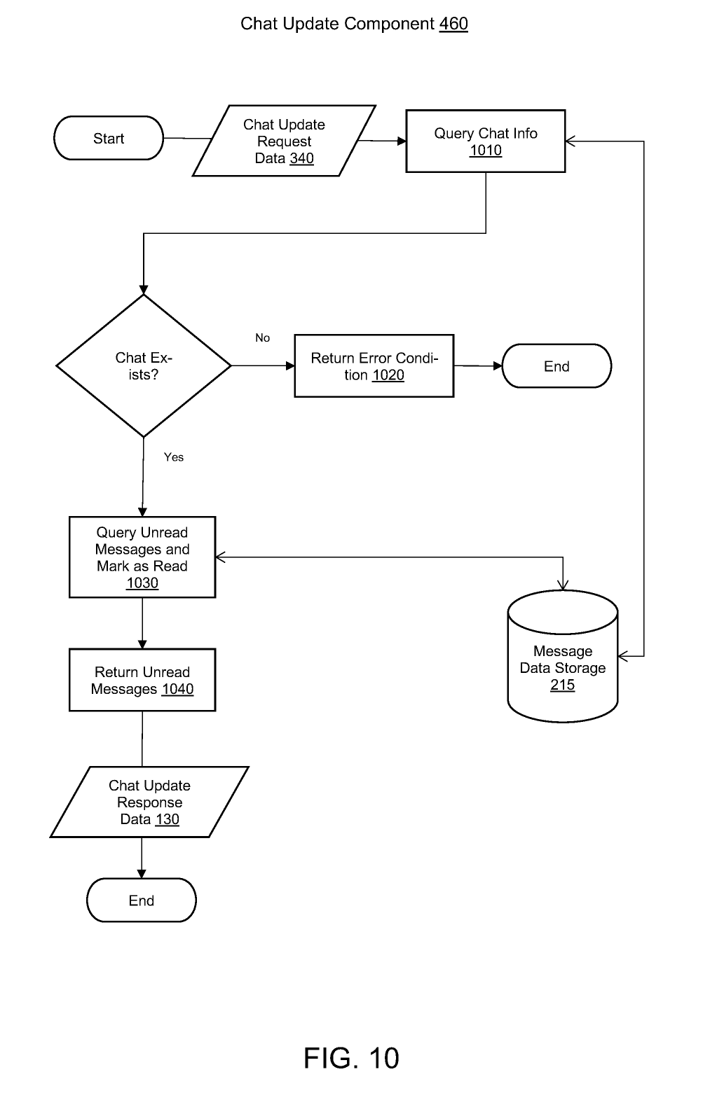

FIG. 10 illustrates an embodiment of a chat update component 460 performing a single chat update.

The chat update component 460 may receive chat update request data 340 comprising the chat identification and it may query chat info to the message data storage 215 at block 1010.

In case the chat does not exists, the chat update component 460 may return an error condition at block 1020.

In case the chat exists, the chat update component 460 may query unread messages of said chat to the message data storage 215 and mark them as read messages at block 1030. The chat update component 460 may then return chat update response data 130 comprising a list of unread messages along with their content at block 1040.

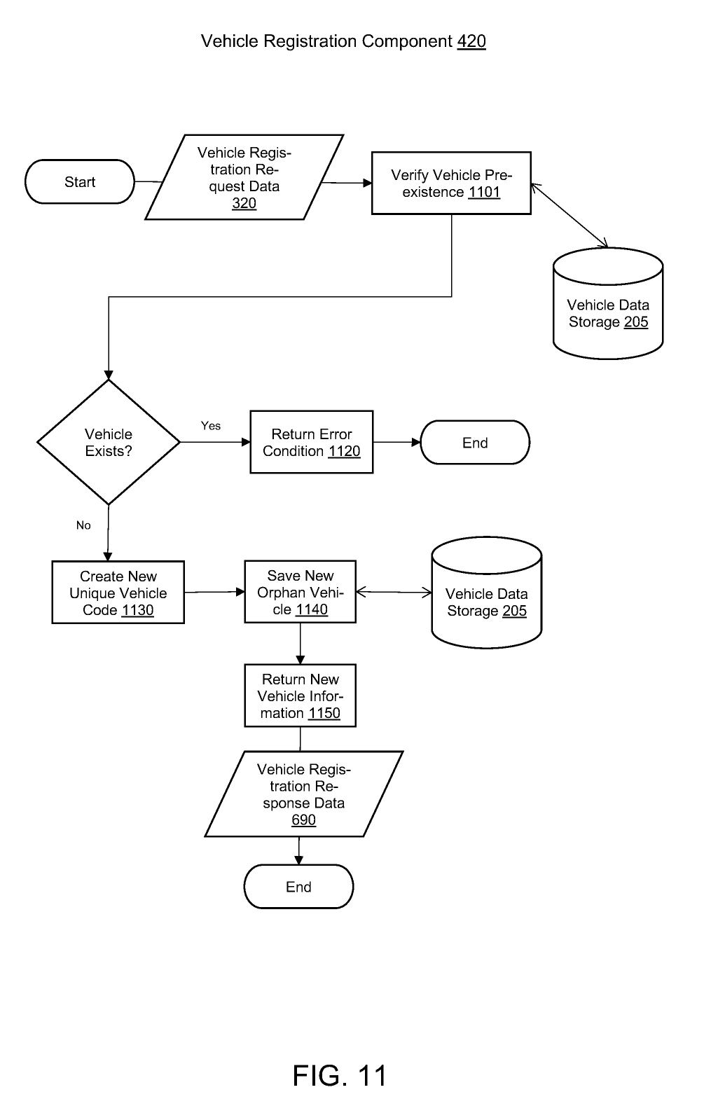

FIG. 11 illustrates an embodiment of a vehicle registration component 420 performing an orphan vehicle registration.

The vehicle registration component 420 may receive vehicle registration request data 320 comprising PAVICI and, verify vehicle pre-existence in the vehicle data storage 205 at block 1101. Said verification may be performed by checking if the PAVICI received is already recorded in another vehicle record in the vehicle data storage 205.

In case the vehicle previously exists, the vehicle registration component 420 may return an error condition at block 1120, making no changes to the vehicle data storage 205.

In case the vehicle does not previously exists, the vehicle registration component 420 may create a new unique vehicle code at block 1130 and may save the newly created orphan vehicle record in the vehicle data storage 205 at block 1140. Said vehicle record may comprise the vehicle registration request data 320, said new unique vehicle code and, no systemwide-unique user identification meaning the vehicle record may not be linked to any user (i.e., an orphan vehicle). Once the unlinked vehicle is created and recorded, the vehicle registration component 420 may return vehicle registration response data 690 comprising the systemwide-unique vehicle identification of the newly created vehicle record at block 1150.

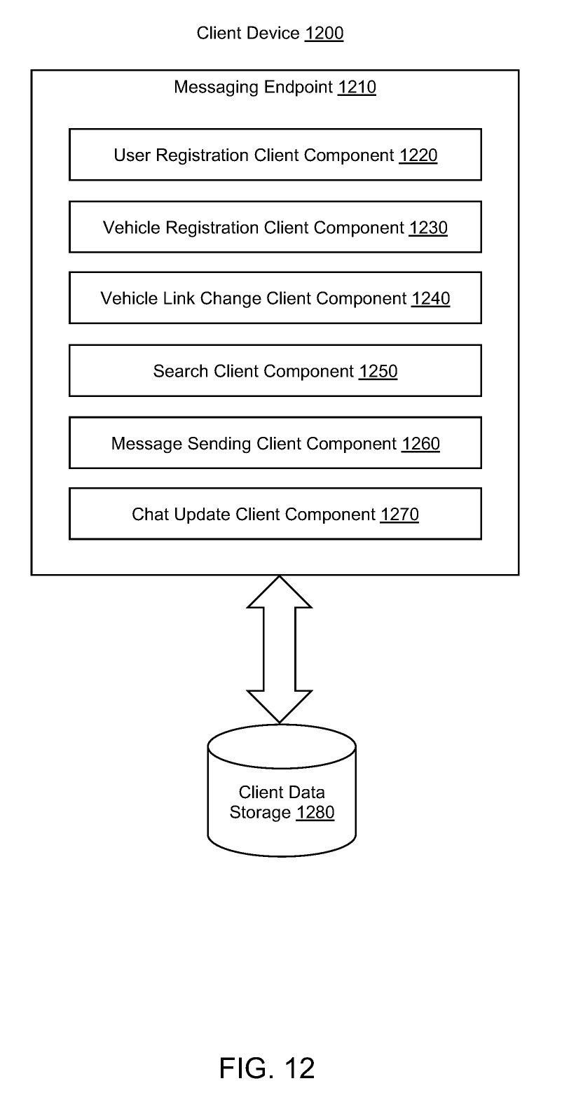

FIG. 12 illustrates an embodiment of a client device 1200.

The client device 1200 may comprise a messaging endpoint 1210 and a client data storage 1280. Said client data storage 1280 may store message content (e.g., text, images, video, audio) from messages already sent, from messages to be sent, from messages received and, may stores user profile and vehicle profile data. The client device 1200 may implement the source client device 150 and/or the destination client device 155, and the messaging endpoint 1210 may implement the source messaging endpoint 135 and/or the destination messaging endpoint 140.

A messaging endpoint 1210 may comprise a user registration client component 1220, a vehicle registration client component 1230, a vehicle link change client component 1240, a search client component 1250, a message sending client component 1260 and a chat update client component 1270.

A messaging endpoint 1210 may perform the core functions of the client system, i.e., the functions performed by components 1220, 1230, 1240, 1250, 1260 and 1270, and may access and use the client data storage 1280 for performing data storage and retrieval management.

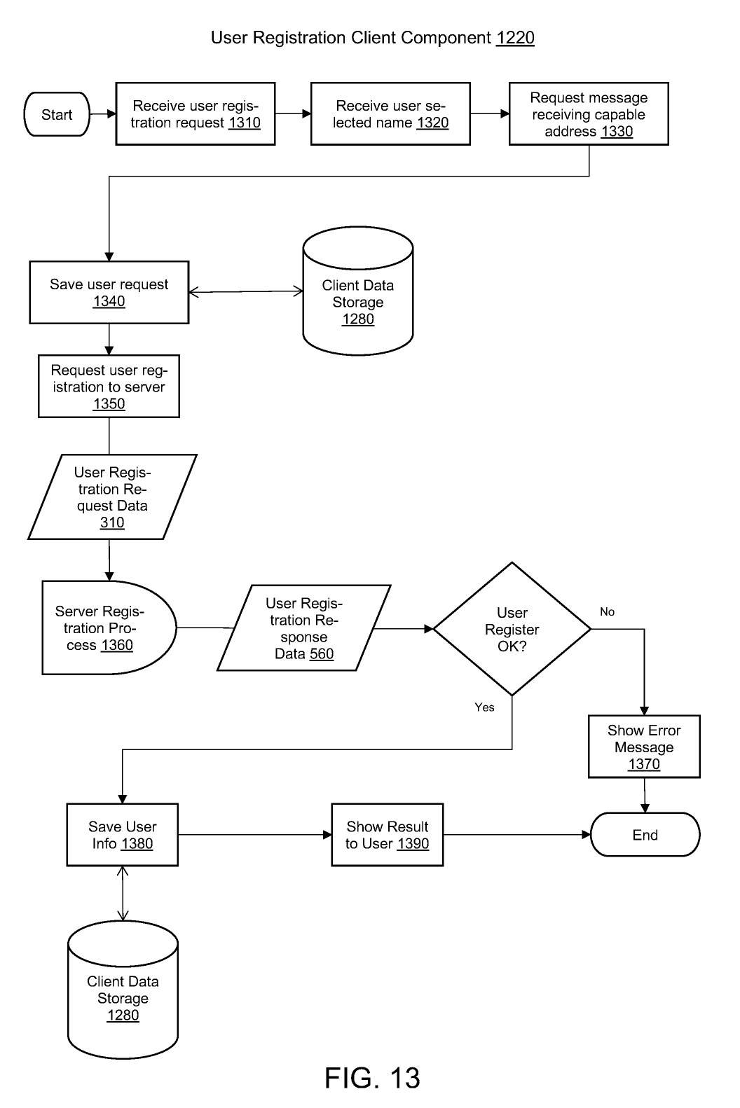

FIG. 13 illustrates an embodiment of a user registration client component 1220 performing a user registration.

The user registration client component 1220 may receive a request from the user to perform a user registration at block 1310. Said component may receive a user selected name from said user at block 1320 and a message receiving capable address at block 1330. In some embodiments, the user may enter the address, in other embodiments, the user registration client component 1220 may use the messaging endpoint address. Said component may save user registration request in the client data storage 1280 at block 1340.

The user registration client component 1220 may request a user registration to the messaging service 110 and may send user registration request data 310 at block 1350.

The user registration client component 1220 may wait until the server processes the request and responds, at block 1360. Once the server responds with user registration response data 560, said component may show the user an error message if the registration process did not end successfully at block 1370. Otherwise, said component may save the new user information in the client data storage 1280 at block 1380 and may show the result to the user at block 1390.

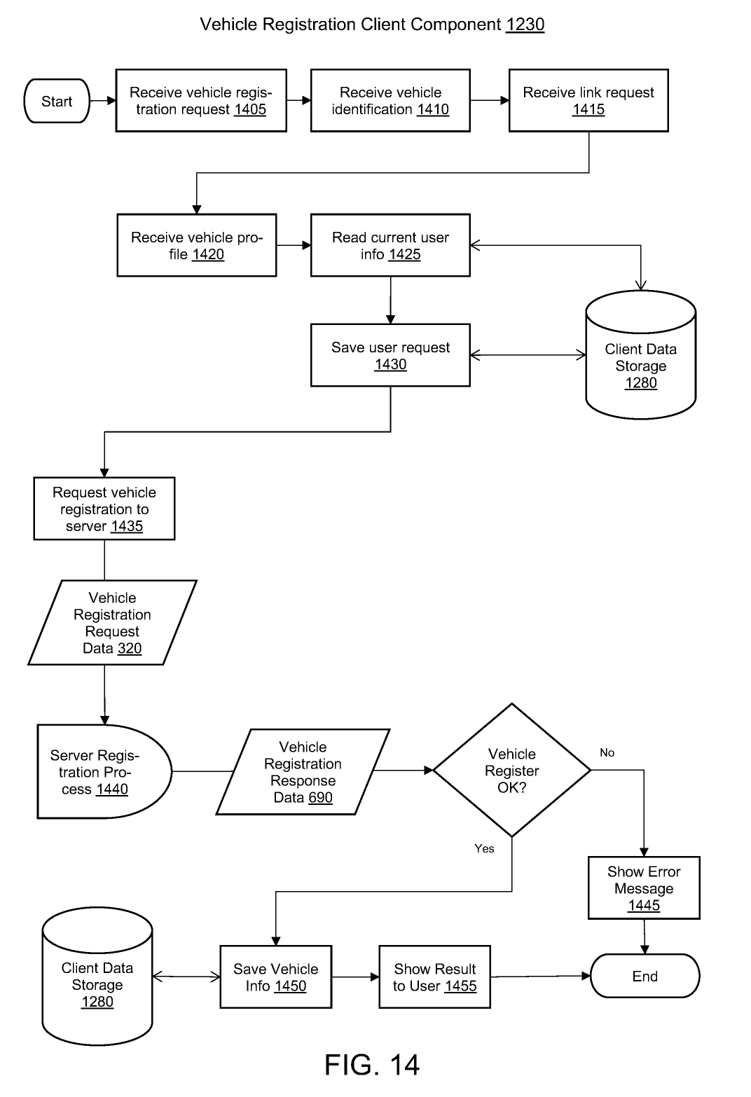

FIG. 14 illustrates an embodiment of a vehicle registration client component 1230 performing a vehicle registration.

The vehicle registration client component 1230 may receive a request from the user to perform a vehicle registration at block 1405. Said component may receive a vehicle identification from said user at block 1410 and an indication whether the vehicle should be linked to said user or not, at block 1415. Said component may receive the vehicle profile information from the user at block 1420 and may read current user info from the client data storage 1280 at block 1425. In some embodiments, the vehicle profile information may comprise the vehicle country, state and profile level. In other embodiments, it may comprise more or less information about the vehicle. Said component may save the vehicle registration request information in the client data storage 1280 at block 1430.

The vehicle registration client component 1230 may request a vehicle registration to the messaging service 110 and may send vehicle registration request data 320 at block 1435.

The vehicle registration client component 1230 may wait until the server processes the request and responds, at block 1440. Once the server responds with vehicle registration response data 690, said component may show the user an error message if the registration process did not end successfully at block 1445. Otherwise, said component may save the new vehicle information in the client data storage 1280 at block 1450 and may show the result to the user at block 1455.

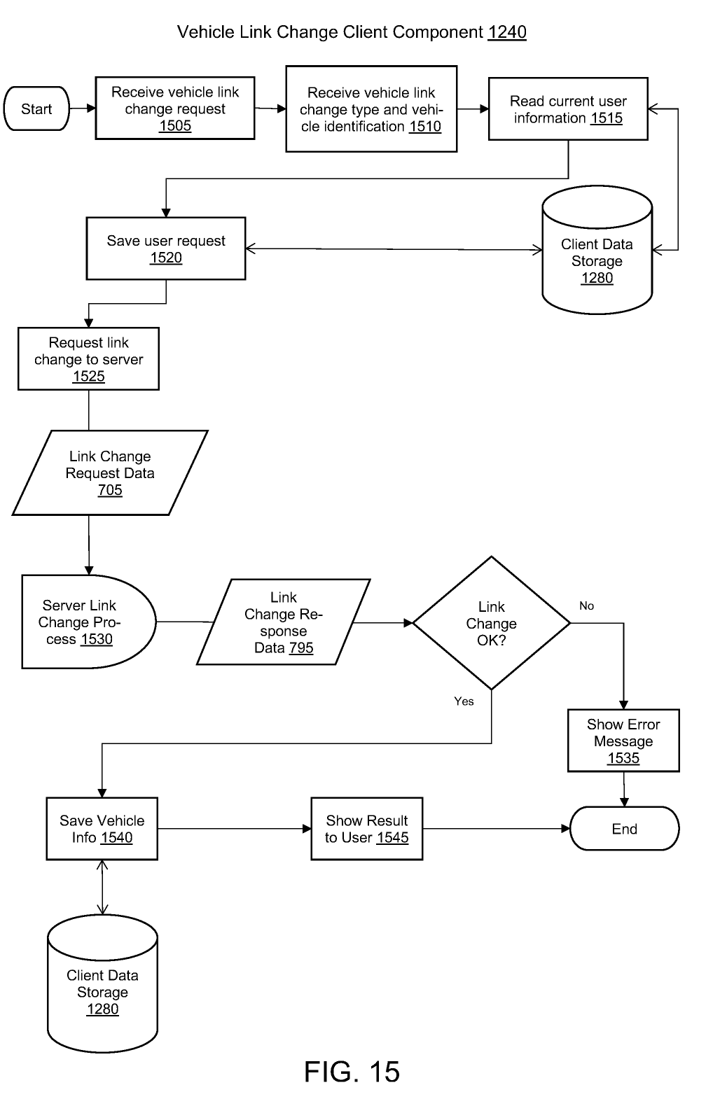

FIG. 15 illustrates an embodiment of a vehicle link change client component 1240 performing a vehicle link change.

The vehicle link change client component 1240 may receive a request from the user to perform a vehicle link change at block 1505. Said component may receive a vehicle identification and a link change type (i.e., link or unlink) from said user at block 1510. Said component may read current user info from the client data storage 1280 at block 1515. Said component may save the vehicle link change request information in the client data storage 1280 at block 1520.

The vehicle link change client component 1240 may request a vehicle link change to the messaging service 110 and may send link change request data 705 at block 1525.

The vehicle link change client component 1240 may wait until the server processes the request and responds, at block 1530. Once the server responds with link change response data 795, said component may show the user an error message if the link change process did not end successfully at block 1535. Otherwise, said component may save the vehicle information in the client data storage 1280 at block 1540 and may show the result to the user at block 1545.

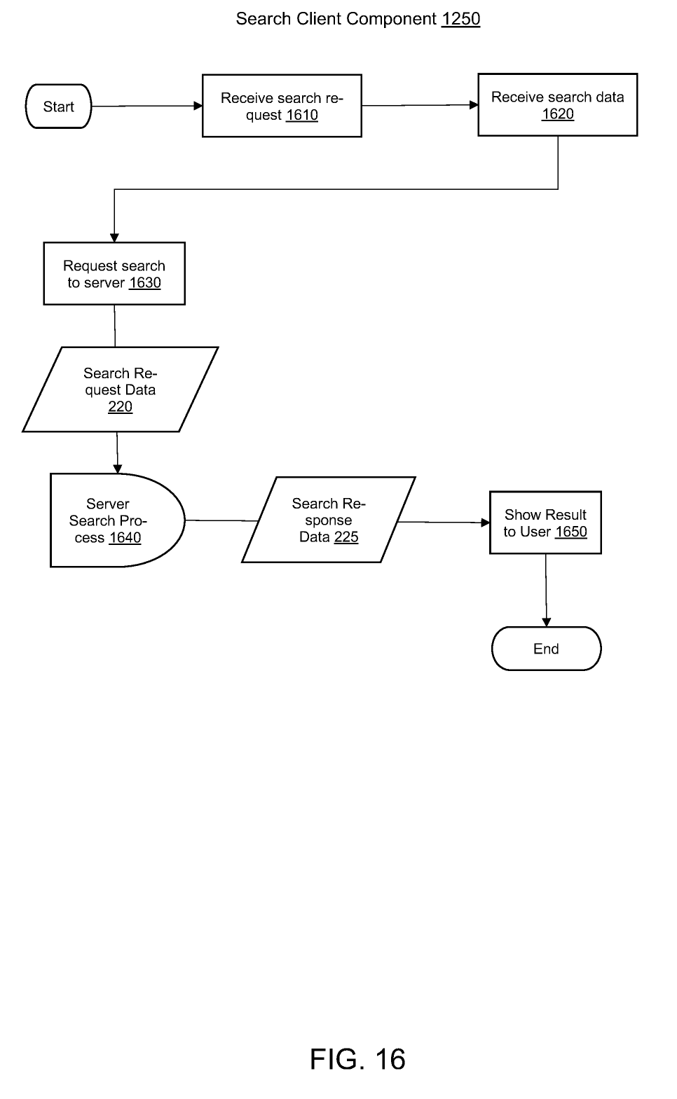

FIG. 16 illustrates an embodiment of a search client component 1250 performing a vehicle or user search.

The search client component 1250 may receive a request from the user to perform a vehicle or user search at block 1610. Said component may receive search data (e.g., a portion of a vehicle identification, a portion of a user selected name) from said user at block 1620.

The search client component 1250 may request a vehicle or user search to the messaging service 110 and may send search request data 220 at block 1630.

The search client component 1250 may wait until the server processes the request and responds, at block 1640. Once the server responds with search response data 225, said component may show the result to the user at block 1650.

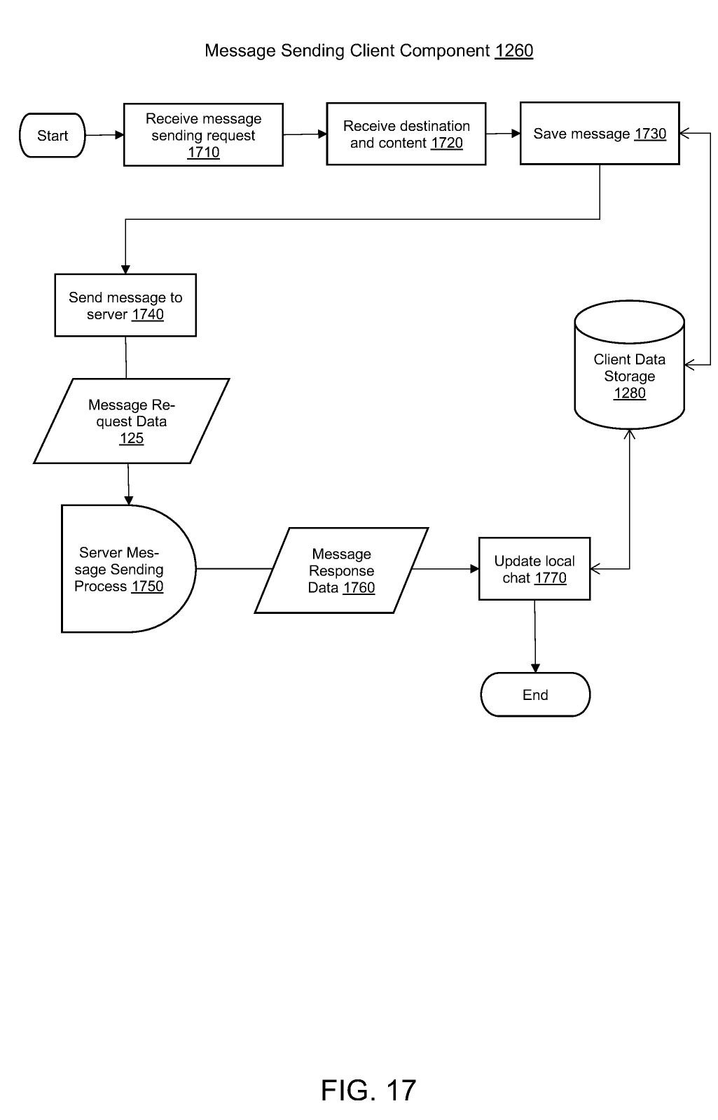

FIG. 17 illustrates an embodiment of a message sending client component 1260 sending a message.

The message sending client component 1260 may receive a request from the user to send a message at block 1710. Said component may receive the destination of the message (i.e., the vehicle or user) and the message content from said user at block 1720. Said component may save the message information in the client data storage 1280 at block 1730.

The message sending client component 1260 may send the message to the messaging service 110 and may send message request data 125 at block 1740.

The message sending client component 1260 may wait until the server processes the request and responds, at block 1750. Once the server responds with message response data 1760, said component may update local chat and show the result to the user at block 1770.

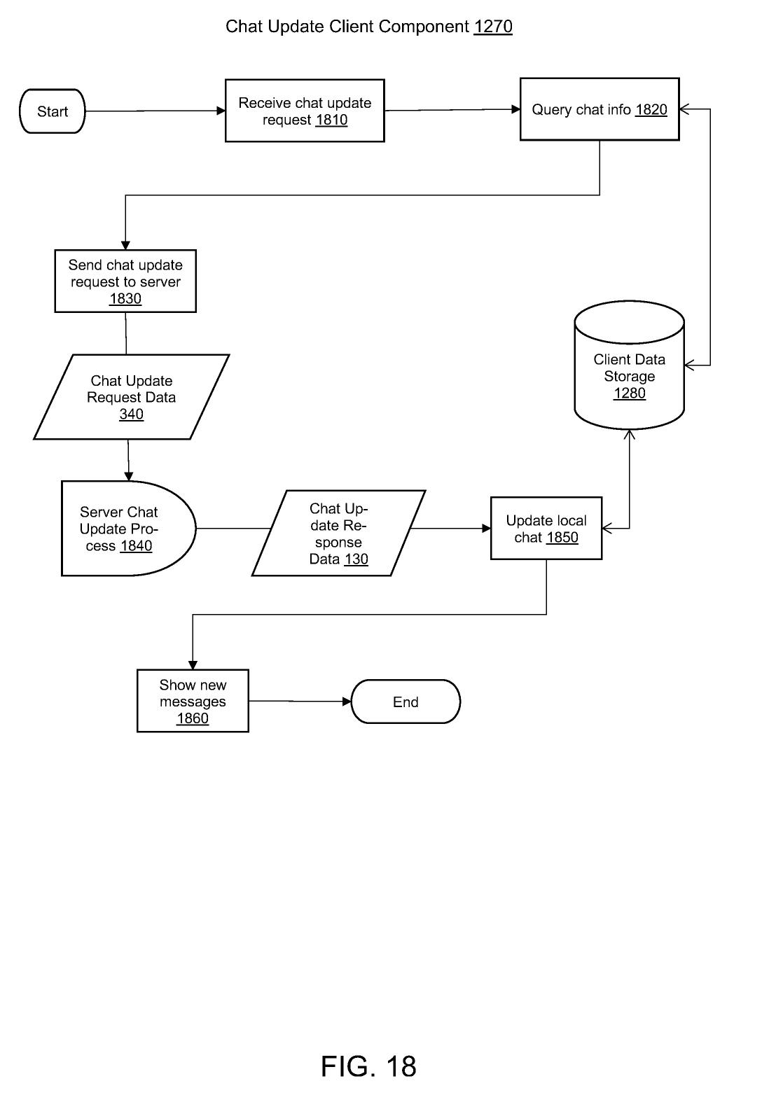

FIG. 18 illustrates an embodiment of a chat update client component 1270 performing a local chat update.

The chat update client component 1270 may receive a request from the user to update a local chat at block 1810. Said component may query the chat information from the client data storage 1280 at block 1820.

The chat update client component 1270 may send the chat update request to the messaging service 110 sending chat update request data 340 at block 1830.

The chat update client component 1270 may wait until the server processes the request and responds, at block 1840. Once the server responds with chat update response data 130, said component may update local chat at block 1850 and show the updated chat to the user at block 1860.

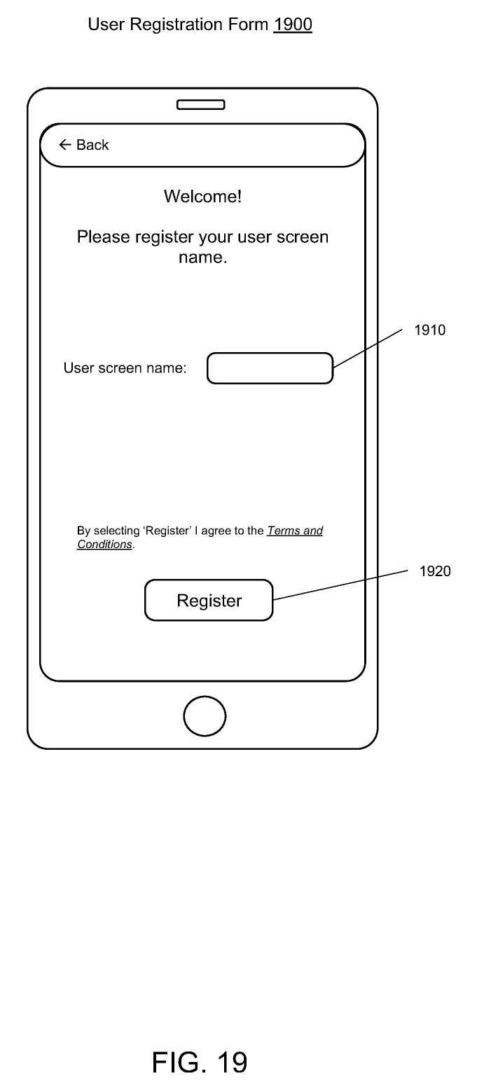

FIG. 19 illustrates an embodiment of a user registration form 1900.

Through the user registration form 1900 the user may access the function provided by the user registration client component 1220.

The user may enter a user selected name in the user screen name field 1910 and may press the register button 1920 to request the user registration.

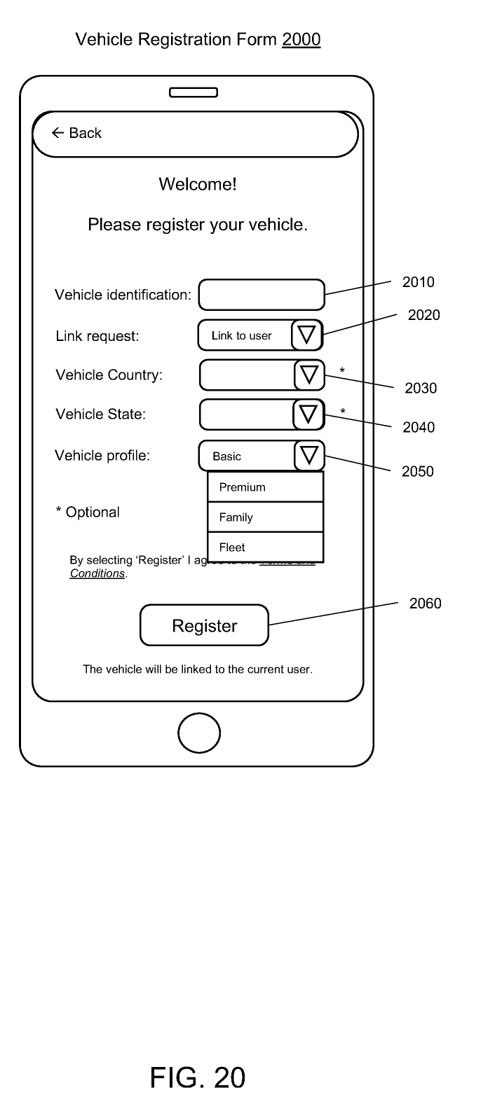

FIG. 20 illustrates an embodiment of a vehicle registration form 2000.

Through the vehicle registration form 2000 the user may access the function provided by the vehicle registration client component 1230.

The user may enter PAVICI in the vehicle identification field 2010, may select a link type (i.e., link or unlink vehicle to user) from the field link request 2020, may select a country from the vehicle country field 2030, may select a state from the vehicle state field 2040, may select a profile for the vehicle from the vehicle profile field 2050 and may press the register button 2060 to request the vehicle registration.

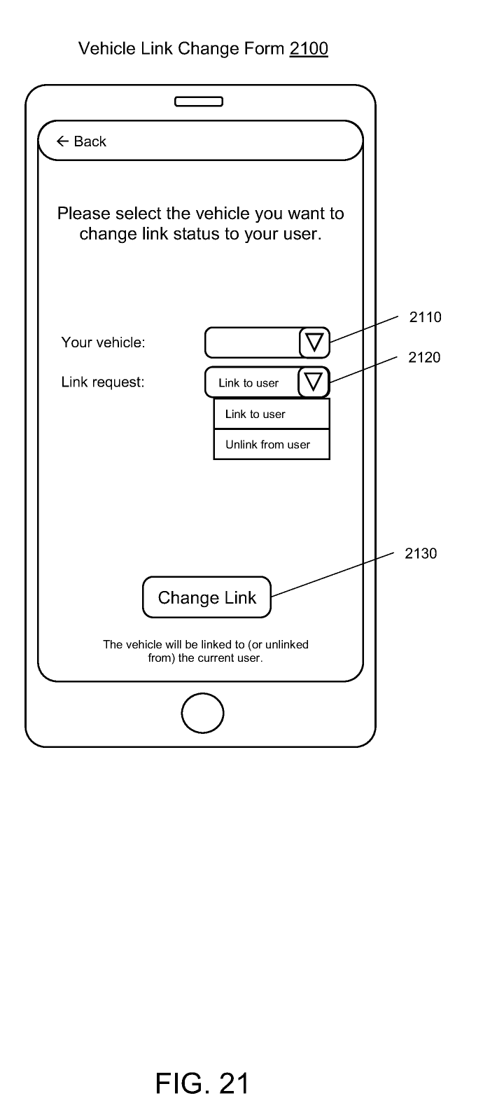

FIG. 21 illustrates an embodiment of a vehicle link change form 2100.

Through the vehicle link change form 2100 the user may access the function provided by the vehicle link change client component 1240.

The user may select a vehicle identification in the ‘your vehicle’ field 2110, may select a link type (i.e., link or unlink vehicle to user) from the link request field 2120 and may press the change link button 2130 to request the vehicle link change.

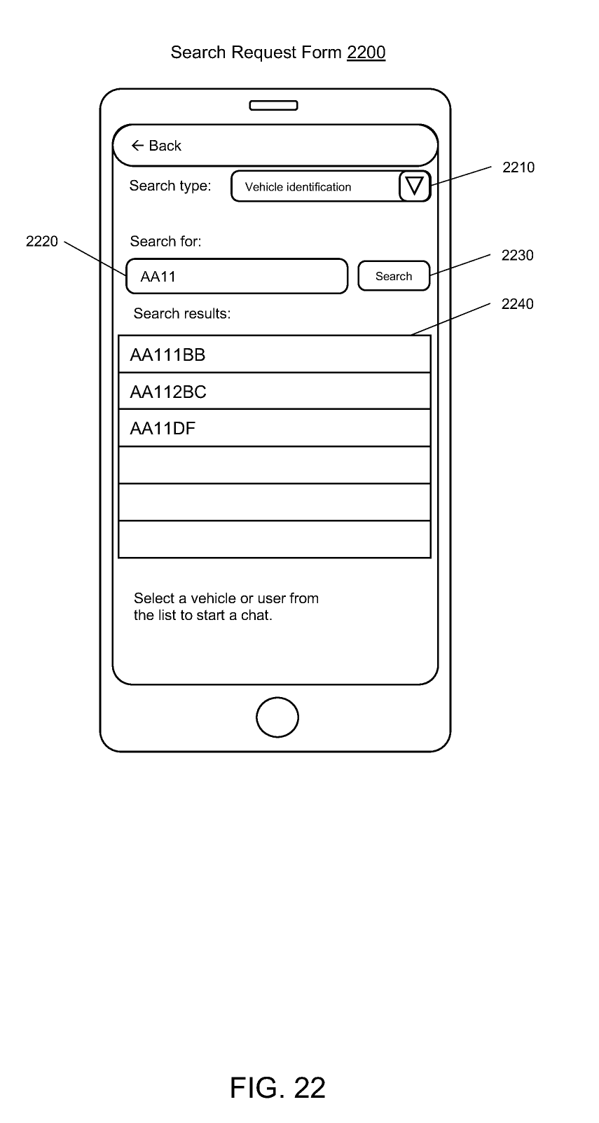

FIG. 22 illustrates an embodiment of a search request form 2200.

Through the search request form 2200 the user may access the function provided by the search client component 1250.

The user may select a search type in the search type field 2210, may enter a search string in the search for field 2220 according to the search type selected (i.e., a portion of a vehicle identification or a portion of a user selected name) and may press the search button 2230 to request the search.

The search request form 2200 may show the search result in the search results list 2240.

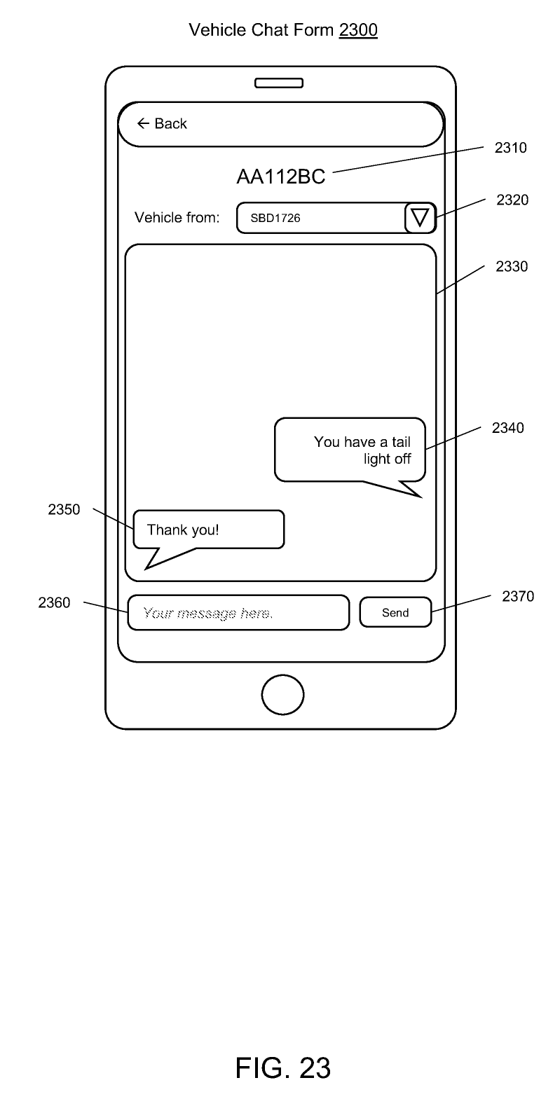

FIG. 23 illustrates an embodiment of a vehicle chat form 2300.

Through the vehicle chat form 2300 the user may access the function provided by the message sending client component 1260 and by the chat update client component 1270. Said form may display the vehicle identification or user selected name 2310 the user is chatting with.

The user may select a vehicle from the vehicle from field 2320, may enter a message content in the message field 2360 and may press the send button 2370 to request the message to be sent. The message may be sent with the systemwide-unique vehicle identification as a sender of the message.

The vehicle chat form 2300 may show the message sent 2340 in the chat list 2330. If the destination user replies, said form may show the reply 2350 in the chat list 2330. Messages may be sent or received in the chat without limitation in the order of messages or content type (e.g., text, preformatted text, images, audio, video). The embodiments are not limited by this example.

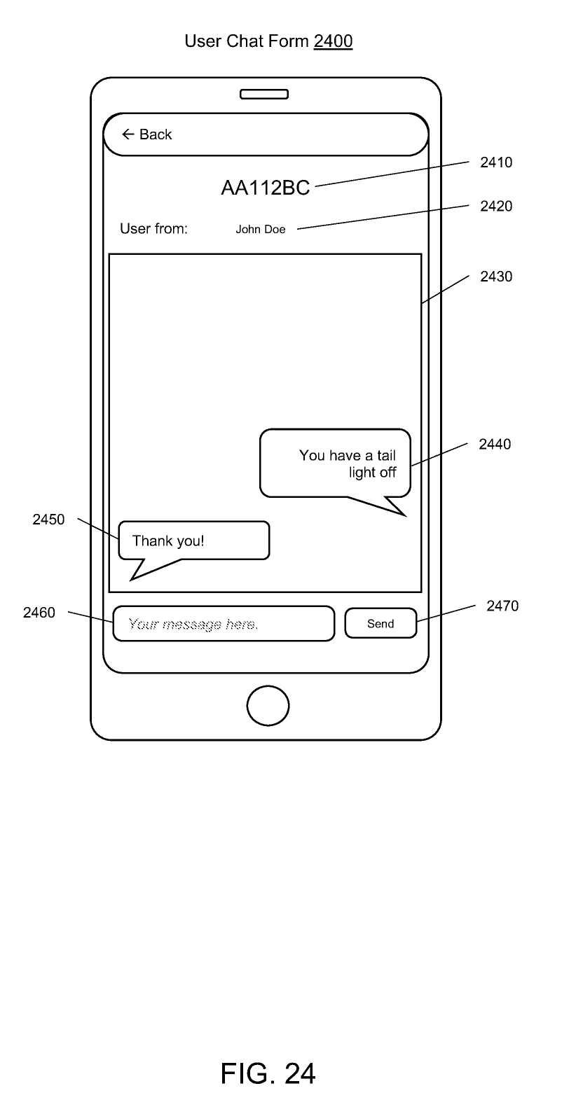

FIG. 24 illustrates an embodiment of a user chat form 2400.

Through the user chat form 2400 the user may access the function provided by the message sending client component 1260 and by the chat update client component 1270. Said form may display the vehicle identification or user selected name 2410 the user is chatting with and the user selected name of the current user 2420.

The user may enter a message content in the message field 2460 and may press the send button 2470 to request the message to be sent. The message may be sent with the systemwide-unique user identification as a sender of the message.

The user chat form 2400 may show the message sent 2440 in the chat list 2430. If the destination user replies, said form may show the reply 2450 in the chat list 2430. Messages may be sent or received in the chat without limitation in the order of messages or content type (e.g., text, preformatted text, images, audio, video). The embodiments are not limited by this example.

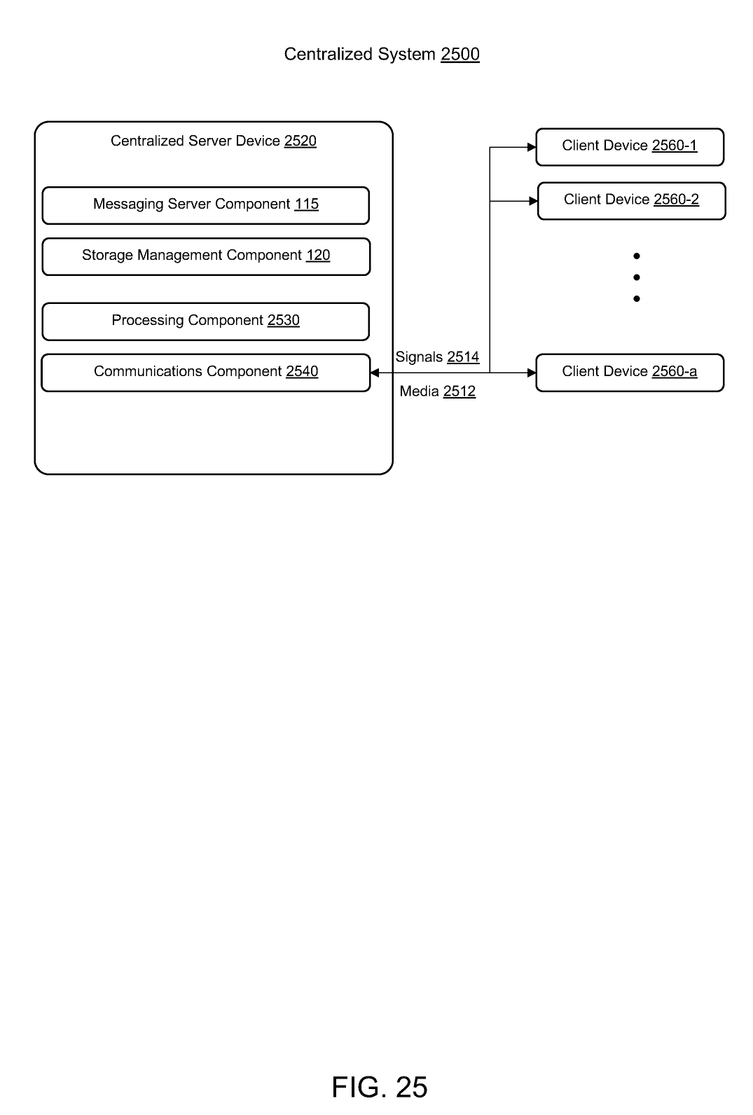

FIG. 25 illustrates a block diagram of a centralized system 2500. The centralized system 2500 may implement some or all of the structure and/or operations for the messaging service 110 in a single computing entity, such as entirely within a single centralized server device 2520.

The centralized server device 2520 may comprise any electronic device capable of receiving, processing, and sending information for the messaging service 110. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The centralized server device 2520 may execute processing operations of logic for the messaging service 110 using a processing component 2530. The processing component 2530 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The centralized server device 2520 may execute communications operations or logic for the messaging service 110 using communications component 2540. The communications component 2540 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 2540 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 2512 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The centralized server device 2520 may correspond to the server device 145 and may implement both the messaging server component 115 and the storage management component 120. The centralized server device 2520 may communicate with the a plurality of client devices 2560, such as may include source client device 150 and destination client device 155, over a communications media 2512 using communications signals 2514 via the communications component 2540.

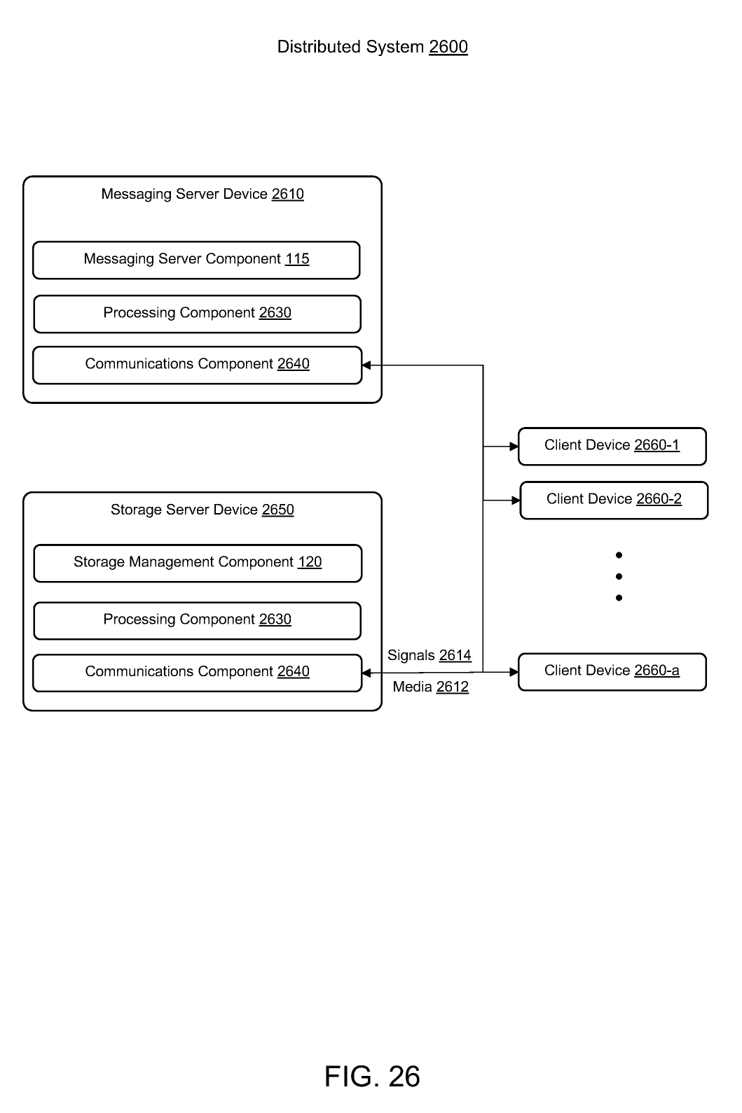

FIG. 26 illustrates a block diagram of a distributed system 2600. The distributed system 2600 may distribute portions of the structure and/or operations for the messaging service 110 across multiple computing entities. Examples of distributed system 2600 may include without limitation a client-server architecture, a 3-tier architecture, an N-tier architecture, a tightly coupled or clustered architecture, a peer-to-peer architecture, a master-slave architecture, a shared database architecture, and other types of distributed systems. The embodiments are not limited in this context.

The distributed system 2600 may comprise a messaging server device 2610 and a storage server device 2650. In general, the messaging server device 2610 and the storage server device 2650 may each comprise a processing component 2630 and a communications component 2640 which are the same or similar to the processing component 2530 and the communications component 2540, respectively, as described with reference to FIG. 25. In another example, the devices 2610, 2650 may communicate over a communications media 2612 using communications signals 2614 via the communications components 2640.

The messaging server device 2610 may comprise or employ one or more client programs that operate to perform various methodologies in accordance with the described embodiments. In one embodiment, for example, the messaging server device 2610 may implement the messaging server component 115.

The storage server device 2650 may comprise or employ one or more server programs that operate to perform various methodologies in accordance with the described embodiments. In one embodiment, for example, the storage server device 2650 may implement the storage management component 120.

The messaging server device 2610 and the storage server device 2650 may communicate with the a plurality of client devices 2660, such as may include source client device 150 and destination client device 155, over the communications media 2612 using communications signals 2614 via the communications components 2640.

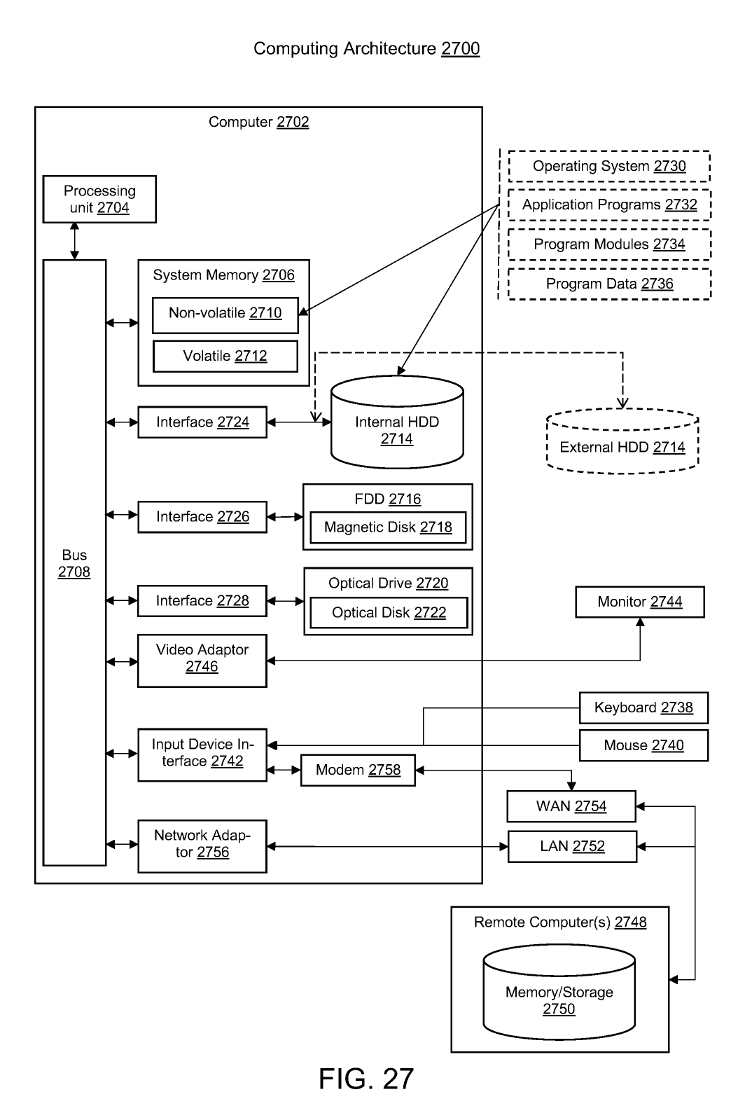

FIG. 27 illustrates an embodiment of an exemplary computing architecture 2700 suitable for implementing various embodiments as previously described. In one embodiment, the computing architecture 2700 may comprise or be implemented as part of an electronic device. Examples of an electronic device may include those described with reference to FIG. 27, among others. The embodiments are not limited in this context.

As used in this application, the terms “system” and “component” are intended to refer to a computer-related entity, either hardware, combination of hardware and software, software, or software in execution, examples of which are provided by the exemplary computing architecture 2700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 2700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 2700.

As shown in FIG. 27, the computing architecture 2700 comprises a processing unit 2704, a system memory 2706 and a system bus 2708. The processing unit 2704 can be any of various commercially available processors, including without limitation an AMD® Athlon®, Duron® and Opteron® processors; ARM® application, embedded and secure processors; IBM® and Motorola® DragonBall® and PowerPC® processors; IBM® and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 2704.

The system bus 2708 provides an interface for system components including, but not limited to, the system memory 2706 to the processing unit 2704. The system bus 2708 can be any of several types of bus structure that may further interconnect to a memory bus (with or without a memory controller), a peripheral bus, and a local bus using any of a variety of commercially available bus architectures. Interface adapters may connect to the system bus 2708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 2700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or non-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 2706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD)) and any other type of storage media suitable for storing information. In the illustrated embodiment shown in FIG. 27, the system memory 2706 can include non-volatile memory 2710 and/or volatile memory 2712. A basic input/output system (BIOS) can be stored in the non-volatile memory 2710.

The computer 2702 may include various types of computer-readable storage media in the form of one or more lower speed memory units, including an internal (or external) hard disk drive (HDD) 2714, a magnetic floppy disk drive (FDD) 2716 to read from or write to a removable magnetic disk 2718, and an optical disk drive 2720 to read from or write to a removable optical disk 2722 (e.g., a CD-ROM or DVD). The HDD 2714, FDD 2716 and optical disk drive 2720 can be connected to the system bus 2708 by a HDD interface 2724, an FDD interface 2726 and an optical drive interface 2728, respectively. The HDD interface 2724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 2710, 2712, including an operating system 2730, one or more application programs 2732, other program modules 2734, and program data 2736. In one embodiment, the one or more application programs 2732, other program modules 2734, and program data 2736 can include, for example, the various applications and/or components of the vehicle identification registration and communication system 100.

A user can enter commands and information into the computer 2702 through one or more wire/wireless input devices, for example, a keyboard 2738 and a pointing device, such as a mouse 2740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 2704 through an input device interface 2742 that is coupled to the system bus 2708, but can be connected by other interfaces such as a parallel port, IEEE 1394 serial port, a game port, a USB port, an IR interface, and so forth.

A monitor 2744 or other type of display device is also connected to the system bus 2708 via an interface, such as a video adaptor 2746. The monitor 2744 may be internal or external to the computer 2702. In addition to the monitor 2744, a computer typically includes other peripheral output devices, such as speakers, printers, and so forth.

The computer 2702 may operate in a networked environment using logical connections via wire and/or wireless communications to one or more remote computers, such as a remote computer 2748. The remote computer 2748 can be a workstation, a server computer, a router, a personal computer, portable computer, microprocessor-based entertainment appliance, a peer device or other common network node, and typically includes many or all of the elements described relative to the computer 2702, although, for purposes of brevity, only a memory/storage device 2750 is illustrated. The logical connections depicted include wire/wireless connectivity to a local area network (LAN) 2752 and/or larger networks, for example, a wide area network (WAN) 2754. Such LAN and WAN networking environments are commonplace in offices and companies, and facilitate enterprise-wide computer networks, such as intranets, all of which may connect to a global communications network, for example, the Internet.

When used in a LAN networking environment, the computer 2702 is connected to the LAN 2752 through a wire and/or wireless communication network interface or adaptor 2756. The adaptor 2756 can facilitate wire and/or wireless communications to the LAN 2752, which may also include a wireless access point disposed thereon for communicating with the wireless functionality of the adaptor 2756.

When used in a WAN networking environment, the computer 2702 can include a modem 2758, or is connected to a communications server on the WAN 2754, or has other means for establishing communications over the WAN 2754, such as by way of the Internet. The modem 2758, which can be internal or external and a wire and/or wireless device, connects to the system bus 2708 via the input device interface 2742. In a networked environment, program modules depicted relative to the computer 2702, or portions thereof, can be stored in the remote memory/storage device 2750. It will be appreciated that the network connections shown are exemplary and other means of establishing a communications link between the computers can be used.

The computer 2702 is operable to communicate with wire and wireless devices or entities using the IEEE 802 family of standards, such as wireless devices operatively disposed in wireless communications (e.g., IEEE 802.8 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.8x (a, b, g, n, etc.) to provide secure, reliable, fast wireless connectivity. A Wi-Fi network can be used to connect computers to each other, to the Internet, and to wire networks (which use IEEE 802.3-related media and functions).

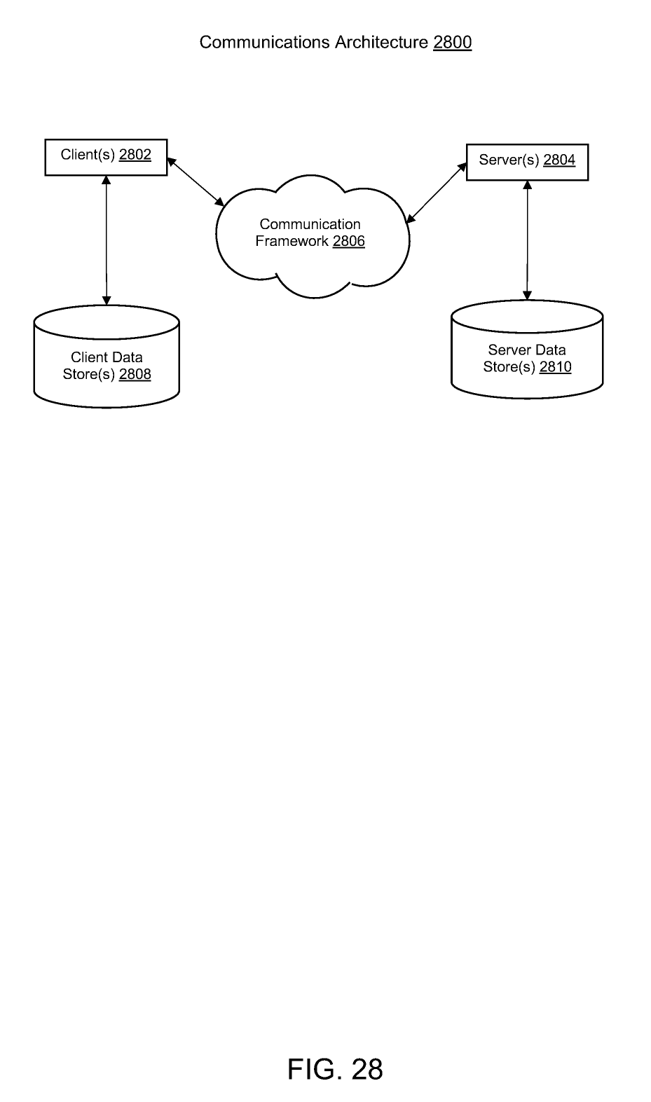

FIG. 28 illustrates a block diagram of an exemplary communications architecture 2800 suitable for implementing various embodiments as previously described. The communications architecture 2800 includes various common communications elements, such as a transmitter, receiver, transceiver, radio, network interface, baseband processor, antenna, amplifiers, filters, power supplies, and so forth. The embodiments, however, are not limited to implementation by the communications architecture 2800.

As shown in FIG. 28, the communications architecture 2800 includes one or more clients 2802 and servers 2804. The clients 2802 may implement the source client device 150 or destination client device 155. The servers 2804 may implement the server device 145 or the alternatives disclosed in FIG. 26. The clients 2802 and the servers 2804 are operatively connected to one or more respective client data stores 2808 and server data stores 2810 that can be employed to store information local to the respective clients 2802 and servers 2804, such as cookies and/or associated contextual information.

The clients 2802 and the servers 2804 may communicate information between each other using a communication framework 2806. The communications framework 2806 may implement any well-known communications techniques and protocols. The communications framework 2806 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 2806 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 2802 and the servers 2804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

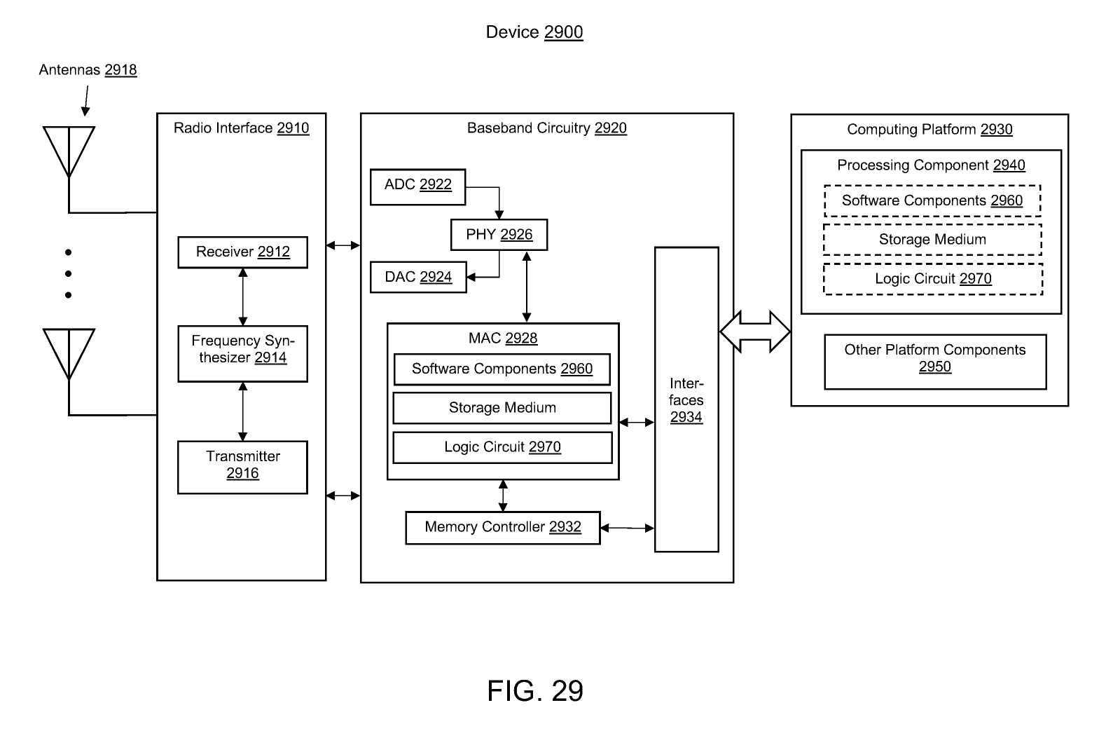

FIG. 29 illustrates an embodiment of a device 2900 for use in a multicarrier OFDM system, such as the vehicle identification registration and communication system 100. Device 2900 may implement, for example, software components 2960 as described with reference to vehicle identification registration and communication system 100 and/or a logic circuit 2970. The logic circuit 2970 may include physical circuits to perform operations described for the vehicle identification registration and communication system 100. As shown in FIG. 29, device 2900 may include a radio interface 2910, baseband circuitry 2920, and computing platform 2930, although embodiments are not limited to this configuration.

The device 2900 may implement some or all of the structure and/or operations for the vehicle identification registration and communication system 100 and/or logic circuit 2970 in a single computing entity, such as entirely within a single device. Alternatively, the device 2900 may distribute portions of the structure and/or operations for the vehicle identification registration and communication system 100 and/or logic circuit 2970 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 2910 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 2910 may include, for example, a receiver 2912, a transmitter 2916 and/or a frequency synthesizer 2914. Radio interface 2910 may include bias controls, a crystal oscillator and/or one or more antennas 2918. In another embodiment, radio interface 2910 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 2920 may communicate with radio interface 2910 to process receive and/or transmit signals and may include, for example, an analog-to-digital converter 2922 for down converting received signals, a digital-to-analog converter 2924 for up converting signals for transmission. Further, baseband circuitry 2920 may include a baseband or physical layer (PHY) processing circuit 2926 for PHY link layer processing of respective receive/transmit signals. Baseband circuitry 2920 may include, for example, a processing circuit 2928 for medium access control (MAC)/data link layer processing. Baseband circuitry 2920 may include a memory controller 2932 for communicating with processing circuit 2928 and/or a computing platform 2930, for example, via one or more interfaces 2934.

In some embodiments, PHY processing circuit 2926 may include a frame construction and/or detection module, in combination with additional circuitry such as a buffer memory, to construct and/or deconstruct communications frames, such as radio frames. Alternatively or in addition, MAC processing circuit 2928 may share processing for certain of these functions or perform these processes independently of PHY processing circuit 2926. In some embodiments, MAC and PHY processing may be integrated into a single circuit.

The computing platform 2930 may provide computing functionality for the device 2900. As shown, the computing platform 2930 may include a processing component 2940. In addition to, or alternatively of the baseband circuitry 2920, the device 2900 may execute processing operations or logic for the vehicle identification registration and communication system 100 and logic circuit 2970 using the processing component 2940. The processing component 2940 (and/or PHY 2926 and/or MAC 2928) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor devices, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 2930 may further include other platform components 2950. Other platform components 2950 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD)) and any other type of storage media suitable of storing information.

Device 2900 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 2900 described herein, may be included or omitted in various embodiments of device 2900, as suitably desired. In some embodiments, device 2900 may be configured to be compatible with protocols and frequencies associated one or more of the 3GPP LTE Specifications and/or IEEE 1002.16 Standards for WMANs, and/or other broadband wireless networks, cite herein, although the embodiments are not limited in this respect.

Embodiments of device 2900 may be implemented using single input single output (SISO) architectures. However, certain implementations may include multiple antennas (e.g., antennas 2918) for transmission and/or reception using adaptive antenna techniques for beamforming or spatial division multiple access (SDMA) and/or using MIMO communication techniques.

The components and features of device 2900 may be implemented using any combination of discrete circuitry, application specific integrated circuits (ASICs), logic gates and/or single chip architectures. Further, the features of device 2900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit”

It should be appreciated that the exemplary device 2900 shown in the block diagram of FIG. 29 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled”, however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations preformed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required suppose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

It is emphasized that the Abstract is provided to allow a reader to quickly ascertain the nature of the technical disclosure. It is submitted with the understanding that it will not be used to interpret or limit the scope or meaning of the claims.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alternations, modifications and variations that fall within the spirit and scope of the claims.

I claim:

1. A computer-implemented method for directing message communications from a sender to a recipient, comprising executing on a processor the steps of:
establishing a database containing a plurality of user records and a plurality of vehicle records, each of the plurality of user records including at least a systemwide-unique user identification, one or more message-receiving capable addresses and none or one user selected name, each of the plurality of vehicle records including at least a systemwide-unique vehicle identification, publicly accessible vehicle identification or characteristic information and none, one or, more than one, systemwide-unique user identification identifying a user record to which said vehicle record is linked or, in case the vehicle record is linked to more than one user record, the user records to which said vehicle records are linked;
receiving a user registration request with none or one message-receiving capable address and, none or one user selected name and, none or one systemwide-unique user identification;
receiving a vehicle registration request with publicly accessible vehicle identification or characteristic information and, none, one or, more than one systemwide-unique user identification, each of said systemwide-unique user identification identifying a user record to which the new vehicle record that is being requested to be registered, is being requested to be linked;
receiving a message sending request including the message content and a systemwide-unique vehicle identification or a systemwide-unique user identification; and
sending a message to a user record's message-receiving capable address with the message content.

2. The method from claim 1, further comprising receiving an orphan vehicle registration request with publicly accessible vehicle identification or characteristic information and without any systemwide-unique user identification identifying a user to which the new vehicle record being requested to be registered is to be linked to.

3. The method from claim 2, further comprising receiving a vehicle record to user record link change request with a systemwide-unique vehicle identification identifying a vehicle record and an indication whether said request is a link request or an unlink request and, one, none or more than one systemwide-unique user identifications, said user identifications identifying the user records to or from which said vehicle record is to be linked to or unlinked from.

4. The method from claim 3, further comprising receiving a search request with at least a character string, matching said character string with at least a portion of one or more of the plurality of vehicle record's publicly accessible vehicle identification or characteristic information or, with at least a portion of one or more of the plurality of user record's user selected name and, returning at least a portion of the matching records with at least a portion of the information contained in said matching records to the requester.

5. The method from claim 4, further comprising receiving a vehicle profile request with the systemwide-unique vehicle identification and returning at least a portion of the information of the vehicle record identified by said systemwide-unique vehicle identification.

6. The method from claim 4, further comprising receiving a registered vehicles' offline message receiving capable addresses request with constraint criteria and returning at least a portion of the information of the message receiving capable addresses of at least a portion of the vehicle records matching said constraint criteria.

7. The method from claim 4, further comprising receiving from a requester user a registered vehicles' messaging personalization request with none, one or more than one constraint criteria identifying the matching information in the message sender's record to prevent message sending from server system to said requester and none, one or more than one constraint criteria identifying matching information in the message sender's record to allow message sending from server system to said requester.

8. An apparatus, comprising:
a processor circuit on a device;
a messaging server component operative on the processor circuit to receive a vehicle registration request with publicly accessible vehicle identification or characteristic information and, none, one or, more than one systemwide-unique user identification, each of said systemwide-unique user identification identifying a user record to which the new vehicle record that is being requested to be registered, is being requested to be linked; and
a storage management component operative to perform data storage and retrieval management, the data comprising vehicle data.

9. The apparatus from claim 8, further comprising:
the messaging server component operative to receive a user registration request with none or one message-receiving capable address and, none or one user selected name and, none or one systemwide-unique user identification; and
the storage management component, the data further comprising user data.

10. The apparatus from claim 9, further comprising:
the messaging server component operative to receive a message sending request including the message content and a systemwide-unique vehicle identification or a systemwide-unique user identification, and to send a message to a user record's message-receiving capable address with the message content; and
the storage management component, the data further comprising messaging data.

11. The apparatus from claim 10, further comprising the messaging server component operative to receive an orphan vehicle registration request with publicly accessible vehicle identification or characteristic information and without any systemwide-unique user identification identifying a user to which the new vehicle record being requested to be registered is to be linked to.

12. The apparatus from claim 11, further comprising the messaging server component operative to receive a vehicle record to user record link change request with a systemwide-unique vehicle identification identifying a vehicle record and an indication whether said request is a link request or an unlink request and, one, none or more than one systemwide-unique user identifications, said user identifications identifying the user records to or from which said vehicle record is to be linked to or unlinked from.

13. The apparatus from claim 12, further comprising the messaging server component operative to receive a search request with at least a character string, matching said character string with at least a portion of one or more of the plurality of vehicle record's publicly accessible vehicle identification or characteristic information or, with at least a portion of one or more of the plurality of user record's user selected name and, returning at least a portion of the matching records with at least a portion of the information contained in said matching records to the requester.

14. The apparatus from claim 13, further comprising the messaging server component operative to receive a vehicle profile request with the systemwide-unique vehicle identification and returning at least a portion of the information of the vehicle record identified by said systemwide-unique vehicle identification.

15. The apparatus from claim 13, further comprising the messaging server component operative to receive a registered vehicles' offline message receiving capable addresses request with constraint criteria and returning at least a portion of the information of the message receiving capable addresses of at least a portion of the vehicle records matching said constraint criteria.

16. The apparatus from claim 13, further comprising the messaging server component operative to receive a registered vehicles' messaging personalization request from a requester user with none, one or more than one constraint criteria identifying the matching information in the message sender's record to prevent message sending from server system to said requester and none, one or more than one constraint criteria identifying matching information in the message sender's record to allow message sending from server system to said requester.

17. At least one non-transitory computer-readable storage medium comprising instructions that, when executed, cause a system to receive a vehicle registration request with publicly accessible vehicle identification or characteristic information and, none, one or, more than one systemwide-unique user identification, each of said systemwide-unique user identification identifying a user record to which the new vehicle record that is being requested to be registered, is being requested to be linked.

18. The computer-readable storage medium of claim 17 comprising further instructions that, when executed, cause a system to receive a user registration request with none or one message-receiving capable address and, none or one user selected name and, none or one systemwide-unique user identification.

19. The computer-readable storage medium of claim 18 comprising further instructions that, when executed, cause a system to receive a message sending request including the message content and a systemwide-unique vehicle identification or a systemwide-unique user identification, and to send a message to a user record's message-receiving capable address with the message content.

20. The computer-readable storage medium of claim 19 comprising further instructions that, when executed, cause a system to receive an orphan vehicle registration request with publicly accessible vehicle identification or characteristic information and without any systemwide-unique user identification identifying a user to which the new vehicle record being requested to be registered is to be linked to.

21. The computer-readable storage medium of claim 20 comprising further instructions that, when executed, cause a system to receive a vehicle record to user record link change request with a systemwide-unique vehicle identification identifying a vehicle record and an indication whether said request is a link request or an unlink request and, one, none or more than one systemwide-unique user identifications, said user identifications identifying the user records to or from which said vehicle record is to be linked to or unlinked from.

22. The computer-readable storage medium of claim 21 comprising further instructions that, when executed, cause a system to receive a search request with at least a character string, matching said character string with at least a portion of one or more of the plurality of vehicle record's publicly accessible vehicle identification or characteristic information or, with at least a portion of one or more of the plurality of user record's user selected name and, returning at least a portion of the matching records with at least a portion of the information contained in said matching records to the requester.

23. The computer-readable storage medium of claim 22 comprising further instructions that, when executed, cause a system to receive a vehicle profile request with the systemwide-unique vehicle identification and returning at least a portion of the information of the vehicle record identified by said systemwide-unique vehicle identification.

24. The computer-readable storage medium of claim 22 comprising further instructions that, when executed, cause a system to receive a registered vehicles' offline message receiving capable addresses request with constraint criteria and returning at least a portion of the information of the message receiving capable addresses of at least a portion of the vehicle records matching said constraint criteria.

25. The computer-readable storage medium of claim 22 comprising further instructions that, when executed, cause a system to receive a registered vehicles' messaging personalization request from a requester user with none, one or more than one constraint criteria identifying the matching information in the message sender's record to prevent message sending from server system to said requester and none, one or more than one constraint criteria identifying matching information in the message sender's record to allow message sending from server system to said requester.

26. A computer-implemented method for exchanging registrations and message communications with a server system, comprising executing on a processor the steps of:
receiving from a user, a request to register a user account in the server system and providing data corresponding to the request to said server system, wherein said data comprising: none or one user selected name and none or one message receiving capable address;
receiving from a user, a request to register a vehicle in the server system and providing data corresponding to the request to the server system, wherein said data comprising: publicly accessible vehicle identification or characteristic information and whether or not said vehicle is requested to be linked to said user in the server system;
receiving from a first user, a request to send a message to a vehicle or to a second user registered in the server system and providing data corresponding to the request to the server system, wherein said data comprising: the system-wide unique vehicle identification or the system-wide unique second user identification and, the message content;
receiving for a first user, from the server system, communications posted by other users that where addressed to said first user's server system's user record or to one of said first user's server system's user record's linked vehicle records within said server system;
receiving from a user a request to send an orphan vehicle registration request to the server system with publicly accessible vehicle identification or characteristic information and without any systemwide-unique user identification identifying a user to which the new vehicle record being requested to be registered is to be linked to;
receiving from a user a request to send a vehicle record to user record link change request to the server system and providing data corresponding to the request to the server system, wherein said data comprising: a systemwide-unique vehicle identification identifying a vehicle record and an indication whether said request is a link request or an unlink request and, one, none or more than one systemwide-unique user identifications, said user identifications identifying the user records to or from which said vehicle record is to be linked to or unlinked from;
receiving from a user a request to send a search request to the server system and providing data corresponding to the request to the server system, wherein said data comprising a character string;
receiving from a user a request to send a vehicle profile request to the server system with a systemwide-unique vehicle identification; receiving from said server system at least a portion of the information of the vehicle record identified by said systemwide-unique vehicle identification and displaying at least a portion of said information received to said user; and
receiving from a user a request to send a registered vehicles' messaging personalization request to the server system with none, one or more than one constraint criteria identifying the matching information in the message sender's record to prevent message sending from server system to said requester and none, one or more than one constraint criteria identifying matching information in the message sender's record to allow message sending from server system to said requester.

27. The method from claim 26, further comprising receiving from a user a request to send a registered vehicles' offline message receiving capable addresses request to the server system with constraint criteria; receiving the resulting information of the vehicle records matching said constraint criteria.

28. An apparatus, comprising:
a processor circuit on a device;
a messaging endpoint operative on the processor circuit to receive from a user, a request to register a user account in the server system and providing data corresponding to the request to said server system, wherein said data comprising: none or one user selected name and none or one message receiving capable address, receive from a user, a request to register a vehicle in the server system and providing data corresponding to the request to the server system, wherein said data comprising: publicly accessible vehicle identification or characteristic information and whether or not said vehicle is requested to be linked to said user in the server system, receive from a first user, a request to send a message to a vehicle or to a second user registered in the server system and providing data corresponding to the request to the server system, wherein said data comprising: the system-wide unique vehicle identification or the system-wide unique second user identification and, the message content, receive for a first user, from the server system, communications posted by other users that where addressed to said first user's server system's user record or to one of said first user's server system's user record's linked vehicle records within said server system, receive from a user a request to send an orphan vehicle registration request to the server system with publicly accessible vehicle identification or characteristic information and without any systemwide-unique user identification identifying a user to which the new vehicle record being requested to be registered is to be linked to, receive from a user a request to send a vehicle record to user record link change request to the server system and providing data corresponding to the request to the server system, wherein said data comprising: a systemwide-unique vehicle identification identifying a vehicle record and an indication whether said request is a link request or an unlink request and, one, none or more than one systemwide-unique user identifications, said user identifications identifying the user records to or from which said vehicle record is to be linked to or unlinked from, receive from a user a request to send a search request to the server system and providing data corresponding to the request to the server system, wherein said data comprising a character string, receive from a user a request to send a vehicle profile request to the server system with a systemwide-unique vehicle identification; receiving from said server system at least a portion of the information of the vehicle record identified by said systemwide-unique vehicle identification and displaying at least a portion of said information received to said user, and receive from a user a request to send a registered vehicles' messaging personalization request to the server system with none, one or more than one constraint criteria identifying the matching information in the message sender's record to prevent message sending from server system to said requester and none, one or more than one constraint criteria identifying matching information in the message sender's record to allow message sending from server system to said requester; and
a client data storage operative to perform data storage and retrieval management, the data comprising vehicle data, user data and messaging data.

29. The apparatus of claim 28, further comprising the messaging endpoint operative to receive from a user a request to send a registered vehicles' offline message receiving capable addresses request to the server system with constraint criteria, and to receive the resulting information of the vehicle records matching said constraint criteria.

30. At least one non-transitory computer-readable storage medium comprising instructions that, when executed, cause a system to receive from a user, a request to register a user account in the server system and providing data corresponding to the request to said server system, wherein said data comprising: none or one user selected name and none or one message receiving capable address, receive from a user, a request to register a vehicle in the server system and providing data corresponding to the request to the server system, wherein said data comprising: publicly accessible vehicle identification or characteristic information and whether or not said vehicle is requested to be linked to said user in the server system, receive from a first user, a request to send a message to a vehicle or to a second user registered in the server system and providing data corresponding to the request to the server system, wherein said data comprising: the system-wide unique vehicle identification or the system-wide unique second user identification and, the message content, receive for a first user, from the server system, communications posted by other users that where addressed to said first user's server system's user record or to one of said first user's server system's user record's linked vehicle records within said server system, receive from a user a request to send an orphan vehicle registration request to the server system with publicly accessible vehicle identification or characteristic information and without any systemwide-unique user identification identifying a user to which the new vehicle record being requested to be registered is to be linked to, receive from a user a request to send a vehicle record to user record link change request to the server system and providing data corresponding to the request to the server system, wherein said data comprising: a systemwide-unique vehicle identification identifying a vehicle record and an indication whether said request is a link request or an unlink request and, one, none or more than one systemwide-unique user identifications, said user identifications identifying the user records to or from which said vehicle record is to be linked to or unlinked from, receive from a user a request to send a search request to the server system and providing data corresponding to the request to the server system, wherein said data comprising a character string, receive from a user a request to send a vehicle profile request to the server system with a systemwide-unique vehicle identification; receiving from said server system at least a portion of the information of the vehicle record identified by said systemwide-unique vehicle identification and displaying at least a portion of said information received to said user, and receive from a user a request to send a registered vehicles' messaging personalization request to the server system with none, one or more than one constraint criteria identifying the matching information in the message sender's record to prevent message sending from server system to said requester and none, one or more than one constraint criteria identifying matching information in the message sender's record to allow message sending from server system to said requester.

31. The computer-readable storage medium of claim 30 comprising further instructions that, when executed, cause a system to receive from a user a request to send a registered vehicles' offline message receiving capable addresses request to the server system with constraint criteria, and to receive the resulting information of the vehicle records matching said constraint criteria.
